(19) United States
(12) Patent Application Publication
(10) Pub. No.: US 2007/0298883 A1
(43) Pub. Date: Dec. 27, 2007

(54) Method and Apparatus for Operatively Controlling a Virtual Reality Scenario in Accordance With Physical Activity of a User

(76) Inventors: Philip Feldman, Catonsville, MD (US); Peter Tsai, Olney, MD (US); Greg Merril, Bethesda, MD (US)

Correspondence Address: EDELL, SHAPIRO & FINNAN, LLC, 1901 RESEARCH BOULEVARD, SUITE 400, ROCKVILLE, MD, 20850, US

(21) Appl. No.: 11/851,460

(22) Filed: Sep. 7, 2007

Related U.S. Application Data
(63) Continuation of application No. 11/562,449, filed on Nov. 22, 2006.
Application No. 11/562,449 is a continuation-in-part of application No. 11/350,284, filed on Feb. 9, 2006.
Application No. 11/350,284 is a continuation-in-part of application No. 10/975,185, filed on Oct. 28, 2004.
Application No. 10/975,185 is a continuation-in-part of application No. 10/806,280, filed on Mar. 23, 2004.
Application No. 10/806,280 is a continuation-in-part of application No. 10/309,565, filed on Dec. 4, 2002, now Pat. No. 7,121,982.
(60) Provisional application No. 60/514,897, filed on Oct. 29, 2003.
(60) Provisional application No. 60/514,897, filed on Oct. 29, 2003.
(60) Provisional application No. 60/699,384, filed on Jul. 15, 2005.
(60) Provisional application No. 60/739,920, filed on Nov. 28, 2005.

(51) Int. Cl. A63F 13/06; G09G 5/00

(52) U.S. Cl. 463/36; 345/156

(57) ABSTRACT

An interface, in the form of an isometric exercise system, according to the present invention includes an effector with at least one sensor, a platform and control circuitry including a processor. The platform accommodates a user in a standing position and includes the effector attached thereto. The sensor measures at least one force applied by a user lower body portion to the effector and causing a measurable strain on the effector. An additional effector with at least one sensor and a game controller or other input device may further be attached to the platform. The sensor measures at least one force applied by a user upper body portion to the additional effector and causing a measurable strain on that effector. The processor receives and processes data corresponding to applied force information for transference to the host computer system to update a virtual reality scenario.

### CROSS-REFERENCE TO RELATED APPLICATIONS

This application is a Continuation-In-Part of U.S. patent application Ser. No. 11/350,284, entitled “Isometric Exercise System and Method of Facilitating User Exercise During Video Game Play” and filed Feb. 9, 2006 (U.S. Patent Application Publication No. 2006/0217243), which is a Continuation-In-Part of U.S. patent application Ser. No. 10/975,185, entitled “Configurable Game Controller and Method of Selectively Assigning Game Functions to Controller Input Devices” and filed Oct. 28, 2004 (U.S. Patent Application Publication No. 2005/0130742), which is a Continuation-In-Part of U.S. patent application Ser. No. 10/806,280, entitled “Game Controller Support Structure and Isometric Exercise System and Method of Facilitating User Exercise During Game Interaction” and filed Mar. 23, 2004 (U.S. Patent Application Publication No. 2004/0180719), which is a Continuation-In-Part of U.S. patent application Ser. No. 10/309,565, entitled “Computer Interactive Isometric Exercise System and Method for Operatively Interconnecting the Exercise System to a Computer System for Use as a Peripheral” and filed Dec. 4, 2002, now U.S. Pat. No. 7,121,982. Further, U.S. patent application Ser. Nos. 10/975,185 and 10/806,280 claim priority from U.S. Provisional Patent Application Ser. No. 60/514,897, entitled “Configurable Game Controller and Method of Selectively Assigning Game Functions to Controller Input Devices” and filed Oct. 29, 2003. Moreover, U.S. patent application Ser. No. 11/350,284 claims priority from U.S. Provisional Patent Application Ser. No. 60/699,384, entitled “Isometric Exercise System and Method of Facilitating User Exercise During Video Game Play” and filed Jul. 15, 2005. In addition, the present application claims priority from U.S. Provisional Patent Application Ser. No. 60/739,920, entitled “Method and Apparatus for Operatively Controlling a Virtual Reality Scenario With an Isometric Exercise System” and filed Nov. 28, 2005. The disclosures of the aforementioned patent, patent application publications and patent applications (provisional and non-provisional) are incorporated herein by reference in their entireties.

### BACKGROUND OF THE INVENTION

1. Technical Field

The present invention relates to interfaces in the form of exercise systems of the types disclosed in the aforementioned patent and patent application publications, U.S. Patent Application Publication No. 2006/0223634 (Feldman et al.) and U.S. patent application Ser. No. 11/133,449, entitled “Force Measurement System for an Isometric Exercise Device” and filed May 20, 2005, the disclosures of which are incorporated herein by reference in their entireties. In particular, the present invention pertains to an isometric exercise device serving as an interface for simulated or virtual environments to enable users to perform physically exerting activities to interact with the simulated environment.

2. Discussion of Related Art

A student performs optimal learning when a combination of physiological and mental stimuli are applied to the student. This combination of factors results in a higher level of arousal, where the arousal level is associated with optimal cognitive function. As the stress (e.g., cognitive, emotional, physiological, etc.) increases, the ability for the individual to function effectively is degraded. This is commonly referred to as the Inverted-U theory, initially postulated by Yerkes and Dodson.

With respect to simulations developed to train for high-stress activities (e.g., military action, etc.), these simulations are utilized to reduce the user response to an automatic response. For example, a dismounted infantry (DI) soldier should decide an action appropriate for a particular situation, and enable soldier reflexes to perform that action. However, if the soldier has been trained in an environment where the physical component of the activity has not been taken into account, the soldier can possibly commit to a course of action that the soldier is physically incapable of performing (e.g., sprinting up to a roof with a heavy pack and calmly engage in sniper activity, etc.). This type of cognitive dissonance may be avoided by including the physical component in training and simulation.

However, problems exist with respect to including physical interfaces in dismounted soldier type simulations. These problems relate to technology and cost. In particular, interfacing with the human body is an extremely challenging problem. For example, a vehicle simulator includes an interface with the soldier that is clearly defined and completely mechanical, whereas a simulation for the dismounted infantry soldier has to account for interaction between the soldier and a general environment including stairs, rocks, doors, weapons and other people.

The related art has attempted to overcome this problem, where interfaces generally can be categorized into two areas including locomotion interfaces and hand interfaces. Since a human may move in a vast array of manners (e.g., walk forward, backward or sideways, crouch, hop, climb stairs, crawl, walk across a tightrope, slide down a pole, etc.), the approach has been to treat humans as vehicles that move across a plane. The simplest of locomotion type interfaces (e.g., the Uniport from Sarcos Research Corp. of Salt Lake City, Utah) resemble bicycles or unicycles, where pedaling enables the user to go forwards or backwards in a virtual environment, while the interfaces include some additional mechanism to perform steering.

In contrast, complex locomotion interfaces include massive omni directional treadmills (e.g., the Treadport from Sarcos Research Corp. of Salt Lake City, Utah). These treadmills are mounted on motion platforms that may be tilted or oriented in any direction. The soldier is positioned in the center of the treadmill through the use of a tether that allows for the inertial forces to be modeled correctly. The systems include displays, generally in the form of large screens (e.g., CAVE), or a head-mounted display.

The mechanical complexity of the interface rises sharply with the number of axes along which the soldier can move. The Uniport is comparatively inexpensive, but behaves essentially like a bicycle. On the other hand, the Treadport is capable of supporting motion in the X and Y axes along with up to thirty degrees of slope, but is extremely impractical and uneconomical.

Hand interface devices have had more marketplace success. For example, Sensable Technologies, Inc. of Woburn, Massachusetts offers an interface (referred to as the Phantom) for use in CAD and medical simulation. Immersion Corporation of San Jose, Calif. offers an interface for virtual prototyping (referred to as CyberForce). Both of these systems enable the user to move a portion of their body through a small volume of space. At the point that the simulation detects the user colliding with a simulated object, the interface applies an opposing force representing the contact.

Further to the cost and complexity of these systems, robotic force type feedback systems are limited and can only apply a small portion of the opposing force that the systems are capable of producing. Since a trivial malfunction of hardware and/or software results in a maximum force being applied, the machine motors of these systems are restricted to prevent injury to the user. The restricted operation prevents the systems from applying sufficient force to simulate hard, impenetrable surfaces in the virtual environment. In other words, the objects within the virtual environment are “spongy”.

In addition, various interface devices are utilized with recreational simulations, such as video games. Generally, the operation of video and computer games is performed by users in a sitting or reclining position (e.g., on a couch, chair, floor, etc.). Accordingly, the use of video games tends to decrease the amount of exercise being performed by users. This lack of sufficient exercise may contribute to a growing population of overweight people or even an epidemic of obesity.

In an attempt to overcome the aforementioned problems with respect to recreational simulations or video games, the related art provides various systems utilizing exercise systems with a virtual environment. Generally, isokinetic and/or isotonic forms of exercise involve moving a user's muscles under resistance through a selected range of motion. Isometric exercise involves the exertion of force by a user against an object that significantly resists movement as a result of the exerted force such that there is substantially minimal or no movement of the user's muscles during the force exertion. Examples of simple forms of isometric exercise include pushing against a stationary surface (e.g., a doorframe or a wall), attempting to pull apart tightly gripped hands or to bend or flex a sufficiently rigid steel bar, etc.

A related art computer controlled exercise system is described in International Publication No. WO 91/11221 (Bond et al.). The computer controlled exercise system sequentially and automatically implements isokinetic, isotonic and isometric exercises to permit a physical therapist to attend to other patients while the computer interacts with the patient to effect a desired therapy. In one embodiment, the motion of a patient's body, such as lifting or twisting the patient's limb, is converted into a runner on a display that competes against another runner. If the patient meets or exceeds the exercise goals, such as a number of repetitions or torque applied to the exercise unit, then the runner representing the patient will match or beat the other runner representing the goal.

Further, an Interactive Video Exercise System (IVES) is disclosed in Dang et al. “Interactive Video Exercise System for Pediatric Brain Injury Rehabilitation”, Proceedings of the RESNA 20^{th} Annual Conference, June 1998. This system provides an instrumented video-game-enhanced exercise program for pediatric brain injury patients, where the system includes an isometric test apparatus, a data processing circuit box, and a SUPER NES system with an adapted game controller. The isometric test apparatus includes a first load cell rigidly mounted onto a metal cross-bar that clamps to two rear legs of a chair. A high tensile cable and an ankle band couple the shank of a subject sitting in the chair to the first load cell. A second load cell is mounted between two aluminum plates which rest on the floor. The subject's foot rests on the top plate against a heel stop and is secured with two straps. Isometric extensions of the subject's knee are measured by the first load cell, and isometric ankle dorsiflexion of the subject is measured by the second load cell. The signal from either load cell is transmitted to the data processing box, where it is processed and compared with a variable threshold value set by a potentiometer. When the transducer's signal exceeds the threshold value, voltage is passed to the adapted game controller whereby the selected operation is executed in a game (e.g., move right, move left, move up, move down, etc.). As a result, the subject can only play the game by performing certain isometric exercises.

However, the above-described exercise systems of the related art suffer from several disadvantages. In particular, interaction between the exercise system and a computer in the previously described International Publication is limited to simple representations on a display that are based upon achieving set goals. Thus, this exercise system does not provide a fully interactive virtual reality environment (e.g., controlling a variety of movements of a character or an object in the scenario as well as other features relating to the scenario). Further, the system is generally not universally compatible with various gaming or other processors and associated “off the shelf” gaming or other applications. This limits the applications for which the system may be utilized. In addition, the system is bulky and includes various components for operation, thereby complicating portability and use for exercise at various locations.

Moreover, the previously described IVES system requires a game controller for a SUPER NES system to be adapted to render the system operable. Thus, the system is generally not universally compatible with various gaming or other processors and associated “off the shelf” gaming or other applications. This limits the applications for which the system may be utilized. Further, the system includes various components requiring assembly for operation, thereby complicating portability and use for exercise at various locations and preventing immediate (e.g., plug and play type) operation. In addition, the IVES system is limited to isometric knee and ankle exercises and, thus, is incapable of being utilized in a variety of different contexts where it is desirable to exercise upper body parts alone or in combination with lower body parts of a user.

### OBJECTS AND SUMMARY OF THE INVENTION

Accordingly, it is an object of the present invention to control virtual reality scenarios in accordance with user movements or exercise.

It is another object of the present invention to interact with a virtual environment based on a user exerting realistic forces to perform a desired action.

Yet another object of the present invention to control a virtual reality scenario in accordance with isometric exercises performed by a user.

Still another object of the present invention is to utilize a universally compatible interface in the form of an isometric exercise system with a wide variety of computer systems capable of executing “off the shelf” games or other software programs, where the compatibility of the system enables immediate (e.g., plug and play type) operation.

A further object of the present invention is to utilize an interface in the form of an isometric exercise system enabling a user to perform upper and/or lower body exercises to control a virtual reality scenario.

The aforesaid objects may be achieved individually and/or in combination, and it is not intended that the present invention be construed as requiring two or more of the objects to be combined unless expressly required by the claims attached hereto.

According to the present invention, an interface in the form of an isometric exercise system facilitating user interaction with a host computer system includes an effector, at least one sensor coupled to the effector, a platform to accommodate the user and control circuitry including a processor. The platform accommodates a user in a standing position and includes the effector attached thereto. The sensor measures at least one force applied by a user lower body portion to the effector, where the applied force effects a strain on or deflects the effector. The effector may be in the form of a metal rod, where the user applies force (e.g., bending, twisting, tension, compressive forces, etc.) that slightly and measurably deforms the effector within its elastic limit. The processor receives and processes data corresponding to applied force information measured by the sensor for transference to the host computer system. The host computer system processes the information to update or respond to events within a virtual reality scenario (e.g., a virtual environment, game, etc.).

Further, an additional effector may be attached to the platform and include at least one sensor coupled thereto and a game controller or other input device. The sensor measures at least one force applied by a user upper body portion to the additional effector, where the applied force effects a strain on or deflects that effector. The additional effector may be in the form of a metal rod, where the user applies force (e.g., bending, twisting, tension, compressive forces, etc.) that slightly and measurably deforms that effector within its elastic limit. The processor receives and processes data corresponding to applied force information measured by the sensor for transference to the host computer system. The host computer system processes the information to update or respond to events within a virtual reality scenario (e.g., a virtual environment, game, etc.) as described above. Thus, user upper and/or lower body exercise may be utilized to interact with a virtual reality scenario.

The present invention provides several advantages. In particular, the isometric interaction inverts the paradigm utilized by the related art devices (such as the CyberForce and the Treadport). In contrast to that paradigm (e.g., allowing the user to move freely and apply unrealistic forces), the isometric interaction of the present invention enables the user to exert realistic forces, while constraining the motion. The ramifications are considerable and include attaining the desired effect without moving parts and the associated high cost and mechanical complexity. Further, reaction times are immediate since there is no lag required for some mechanism to reflect the new state of the simulated world. Moreover, the user may apply forces equivalent to those the user applies in the real world to cause a synthetic object to move in the simulation. Since the present invention employs no moving parts, the isometric interface is extremely simple, rugged and inexpensive. This in combination with the small size of the interface make the interface extremely suitable for group training both in traditional training environments as well as forward deployments. Thus, the present invention system provides a level of integrated physical and cognitive training comparable to systems with significantly greater cost. In addition, the present invention enables a user to perform upper and/or lower body isometric exercises to interact with a virtual environment or game, thereby facilitating exercise and consumption of an increased quantity of calories during game play.

The above and still further objects, features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1 is a view in perspective of an interface device according to the present invention coupled to a simulation system.

FIG. 2 is a view in perspective of the interface device of FIG. 1.

FIG. 3A is a side view in cross-section of the effector bar of the interface device of FIG. 1.

FIG. 3B is a bottom view in perspective of the interface device of FIG. 1.

FIG. 4 is a front view in plan of a control unit for the interface device of FIG. 1.

FIG. 5 is a schematic block diagram of an exemplary control circuit for the interface device of FIG. 1.

FIG. 6 is a view in perspective of an alternative embodiment of the interface device of FIG. 1 according to the present invention.

FIG. 7 is a schematic block diagram of an exemplary control circuit for the interface device of FIG. 6.

FIG. 8 is a view in perspective of the interface device of FIG. 6 configured for connection to a video gaming system.

FIG. 9 is a schematic block diagram of an exemplary control circuit for the interface device of FIG. 8.

### DETAILED DESCRIPTION OF THE PREFERRED EMBODIMENTS

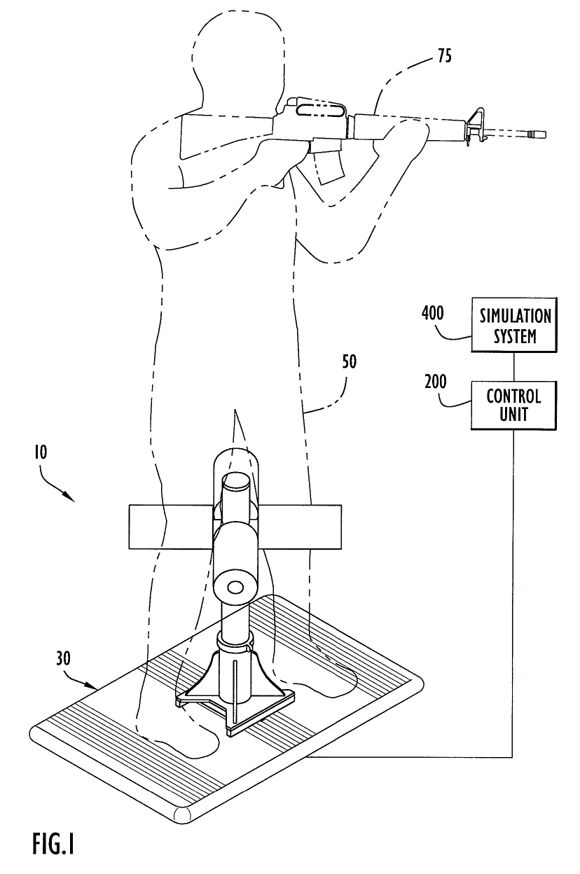

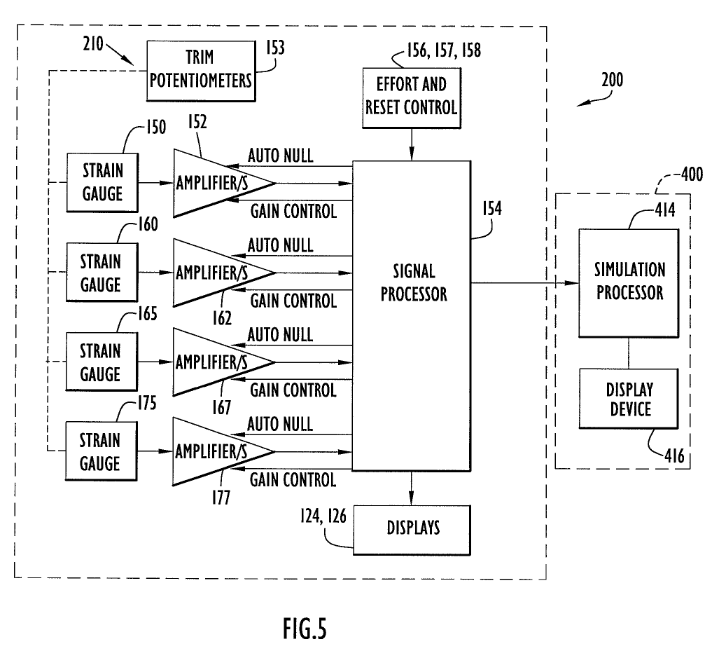

An interface device according to the present invention and coupled to a simulation system is illustrated in FIG. 1. Initially, an interface device 10 according to the present invention is preferably coupled to a device control unit 200 that processes information from the interface device. The control unit is further coupled to a simulation system 400 that provides and updates a simulation or a virtual environment in accordance with manipulation of the interface device by a lower body portion (e.g., legs, etc.) of a user 50. The simulation system typically includes a simulation processor 414 (FIG. 5) and a monitor or other display device 416. For example, user 50 may employ a head set as display device 416 to provide the virtual environment. The simulation processor basically includes a processing device to execute simulation software to provide a virtual reality environment on the display device. The simulation system may be implemented by a Silicon Graphics or Evans and Sutherland simulation system, or by any conventional or other computer or processing system (e.g., IBM-compatible, microprocessor system, personal computer, video gaming system, etc.).

The simulation generally includes characters or objects that are controlled by or interact with user 50. For example, the user may control movement and actions of a character to move through a virtual environment displayed on the display device in accordance with manipulation of interface device 10 by the user lower body portion. Further, the simulation may provide different views or areas of a simulated environment based on user manipulation of the interface device. These different areas may include various objects (e.g., enemy personnel, traps, etc.). Control unit 200 receives and processes signals from the interface device indicating user manipulation of that device. The simulation system receives the processed signals from the control unit and updates the display device to reflect the view and/or movements and/or actions of the character or object in accordance with user manipulation of the interface device.

By way of example, interface device 10 may be employed with a military simulation and serve as a “First Person Shooter” (FPS) attachment, where the interface device is engaged by the legs and/or other lower body portion of user or soldier 50. The interface device tracks the forces that soldier 50 applies with their legs to determine traversal of the virtual environment. In this manner, soldier 50 may handle a firearm or other weapon 75 and move within the virtual environment (e.g., forwards, backwards, sideways, etc.) based on manipulation of the interface device by the soldier legs. For example, soldier 50 may utilize their legs to walk or turn, thereby applying forces to interface device 10 that are measured and processed to indicate velocity and/or direction within the virtual environment as described below. This provides an almost instinctive interaction with the simulation. Since the resistance levels for the interface device are adjustable, soldier 50 can tailor the amount of effort desired to simulate any types of conditions or environments (e.g., hills, terrain, etc.).

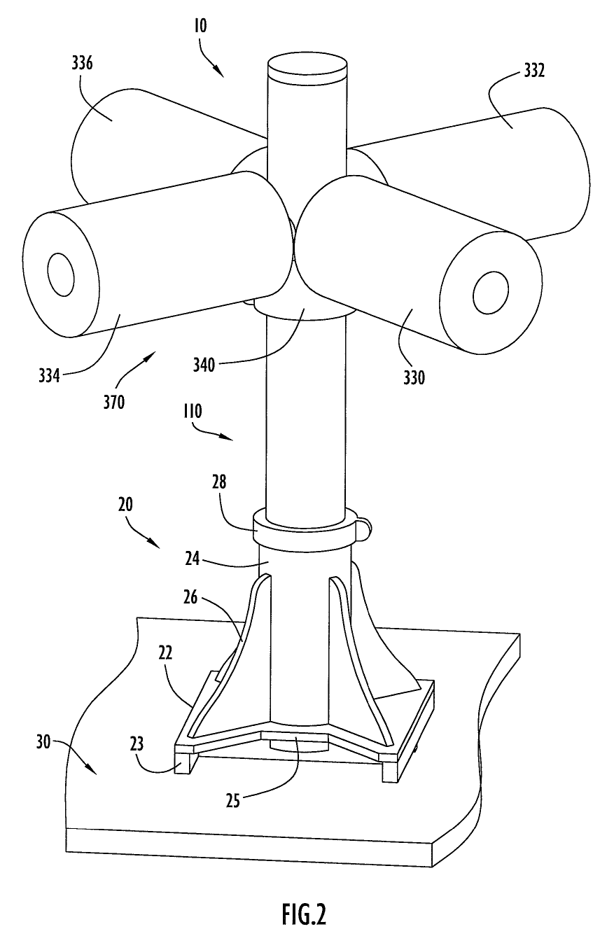

Referring to FIG. 2, interface device 10 includes a base 20, an effector bar 110 and an engagement member 370. Interface device 10 is preferably mounted on a support platform 30. The platform is generally rectangular and includes dimensions sufficient to support user 50 and interface device 10 thereon. Base 20 of the interface device is typically attached to a central location of platform 30, where user 50 stands on the platform in a manner to straddle the interface device with user legs or other lower body portion to manipulate that device and interact with the simulation or virtual environment as described below. Interface device 10 may be secured to the platform at any suitable locations via any conventional or other securing mechanisms (e.g., bolts, clamps, etc.).

Base 20 of interface device 10 includes a floor 22 and a substantially cylindrical receptacle 24. Floor 22 is generally rectangular and includes generally U-shaped recesses 25 defined in opposing side edges of the floor. Floor 22 includes supports 23 attached to the floor bottom surface to elevate floor 22 above platform 30. The supports are in the form of generally rectangular blocks and extend along the non-recessed edges of floor 22. Receptacle 24 extends upward from a substantially central location of floor 22 and includes dimensions sufficient to receive effector bar 110 therein in a substantially upright position for manipulation by user 50 as described below. A series of generally triangular support members 26 are attached to receptacle 24 and floor 22 to support the receptacle. The support members are angularly displaced from each other by approximately ninety degrees and extend from the receptacle toward a respective corner of floor 22. In particular, support members 26 are each in the form of a right triangle with the support member side edges respectively attached to the receptacle and floor in perpendicular relation to each other. The side edge attached to floor 22 extends from the receptacle toward a respective floor corner, while the hypotenuse edge of the support member extends from the upper portion of the side edge attached to the receptacle to the end of the side edge attached to floor 22 near the corresponding floor corner. A substantially circular collar 28 is disposed about effector bar 110 and includes dimensions slightly greater than those of the effector bar and receptacle. The collar basically engages the upper portion of receptacle 24 to secure effector bar 110 within the receptacle in a proper position.

Engagement member 370 is disposed about an upper portion of effector bar 110 to enable a user to engage the engagement member with the user legs and/or other lower body portion and apply forces to manipulate the effector bar to interact with the simulation or virtual environment. The engagement member includes a plurality of generally rectangular contact members 330, 332, 334 and 336 arranged in a cross type configuration (e.g., angularly displaced from each other by approximately ninety degrees) and attached to a substantially annular ring 340 with an open central portion including dimensions sufficient to receive effector bar 110. The engagement member is in slidable relation with the effector bar and may be positioned along the effector bar at any desired location via ring 340. The ring may be implemented by or include any suitable conventional or other securing mechanisms (e.g., an O-ring, clamps, etc.). Contact members 330, 334 are separated by a sufficient distance (e.g., angularly displaced by at least approximately ninety degrees) to enable a user leg and/or other body portion to be disposed between those members. Similarly, contact members 332, 336 are separated by a sufficient distance (e.g., angularly displaced by at least approximately ninety degrees) to enable a user leg and/or other body portion to be disposed between those members. Contact members 330, 332, 334, 336 are preferably padded for user comfort.

Effector bar 110 is received within receptacle 24 in a substantially upright position with engagement member 370 positioned toward the effector bar upper portion as described above. The effector bar is constructed of a suitably rigid material (e.g., a metal alloy) that is capable of being slightly deflected within its elastic limit in response to any combination of bending, twisting, tension and compression forces applied by the user to the bar. While the effector bar is generally cylindrical, it is noted that the effector bar may be of any suitable shape (e.g., bent or curved, V-shaped, etc.) and have any suitable exterior surface geometries (e.g., curved, multifaceted, etc.).

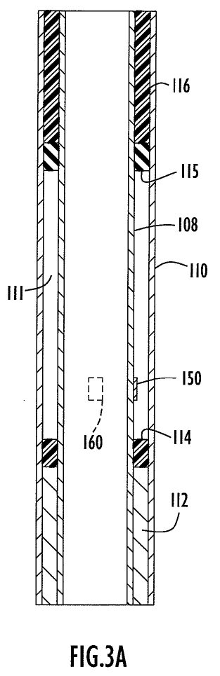

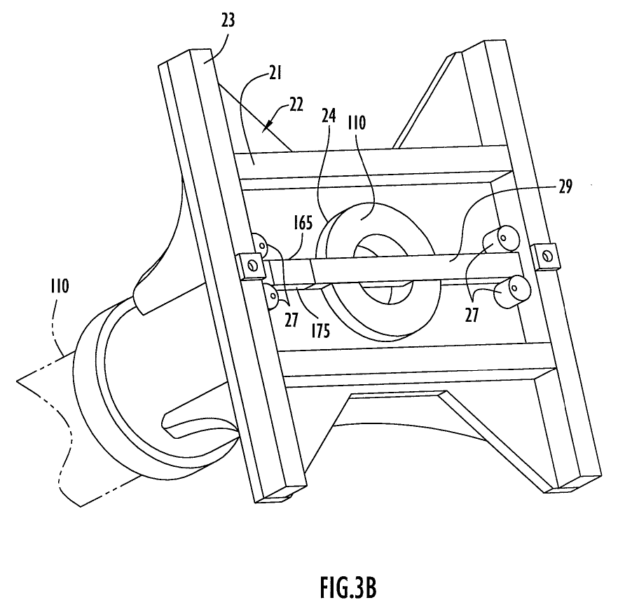

Effector bar 110 includes at least one sensor to measure at least one type of strain applied by the user to that bar. The sensors at a minimum measure force in the forward/reverse (e.g., Y axis) and left/right (e.g., X axis) axes. Additional sensors may be employed to measure up/down forces (e.g., along a Z axis) and rotational forces (e.g., about the Z axis). Preferably, effector bar 110 includes strain gauge sensors 150, 160 (FIG. 3A) that are arranged at suitable locations on the bar, preferably on the effector bar lower portion near receptacle 24. These sensors measure the amount of a strain deformation applied to the bar as a result of the user applying pushing, pulling or lateral forces to the engagement member. By way of example only, sensor 150 may measure force applied to the effector bar along an X-axis (e.g., lateral or left/right forces), while sensor 160 may measure forces applied to the effector bar along a Y-axis (e.g., push/pull or forward/backward forces).

The sensors may be arranged with respect to the effector bar in any suitable manner to measure forces, such as the manners disclosed in the aforementioned patent, patent application and patent application publications. For example, the sensors may be attached directly or indirectly to an effector bar exterior or interior surface to measure the applied forces. Preferably, sensors 150, 160 are secured to a gauge mounting structure disposed within the effector bar in a manner similar to that disclosed in aforementioned U.S. patent application Ser. No. 11/133,449. Referring to FIG. 3A, a gauge mounting structure 108 is secured within a hollow interior of effector bar 110 and extends substantially the length of the effector bar. The effector bar preferably includes at least one open end to facilitate insertion of the gauge mounting structure within the effector bar during assembly. The mounting structure is preferably an elongated hollow tube and has a transverse cross-sectional dimension (e.g., the outer diameter of the internal mounting structure) less than the transverse cross-sectional dimension of the effector bar (e.g., the internal diameter of the effector bar). Thus, an annular gap 111 exists between effector bar 110 and gauge mounting structure 108 nested within the effector bar.

The gauge mounting structure is preferably constructed of a suitable material capable of being slightly deformed within its elastic limit in response to any combination of bending, tension and compression forces applied to the effector bar and translated to the gauge mounting structure as described below. This material is generally more compliant and provides greater flexibility for the mounting structure in comparison to the effector bar. Specifically, when the same force is applied at substantially similar locations and directions to each of effector bar 110 and gauge mounting structure 108, the gauge mounting structure is more flexible and is capable of deforming to a slightly greater extent or degree (e.g., has a greater deformation) than the effector bar without exceeding the elastic limit of the gauge mounting structure. In an exemplary embodiment in which the effector bar is constructed of steel or other suitable metal alloy, the gauge mounting structure is preferably constructed of polyvinyl chloride (PVC) or any other suitable plastic or polymer material that is more compliant or flexible than the metal materials used to construct the effector bar.

The gauge mounting structure is stabilized within and indirectly secured along internal peripheral surface portions of the effector bar via suitable strain transfer materials preferably disposed proximate the longitudinal ends of the gauge mounting structure. The strain transfer materials facilitate transfer of forces or strains that are applied to the effector bar to the gauge mounting structure as described below. A fitting 112 (e.g., a PVC coupling) is secured at a first end of gauge mounting structure 108 that corresponds with the first end of effector bar 110 (e.g., the effector bar end that is secured within receptacle 24). Alternatively, fitting 112 may be secured at the second end of the gauge mounting structure that corresponds with the second, free end of the effector bar (e.g., the effector bar end toward engagement member 370).

The fitting forms a sheath around the longitudinal outer periphery of the gauge mounting structure, and has a transverse cross-sectional dimension that is slightly less than the transverse cross-sectional dimension (e.g., inner diameter) of the effector bar. In addition, the outer surface portions of the fitting frictionally engage the inner surface portions of the effector bar to provide a first indirect contact area or contact bridge between the effector bar and the gauge mounting structure at their corresponding first ends. This contact bridge serves as one strain transfer location in which forces or strains applied to the effector bar are transferred to the gauge mounting structure. A first plug 114 of hardened epoxy resin is secured within annular gap 111 at a location adjacent fitting 112. The first resin plug is secured to inner and outer peripheral surface portions of the effector bar and gauge mounting structure and to the adjacent end surface of the fitting to provide additional surface contact areas between the effector bar and the gauge mounting structure for facilitating strain transfer from the effector bar to the gauge mounting structure.

A second plug 116 of hardened epoxy resin is disposed within annular gap 111 at the corresponding second ends of effector bar 110 and gauge mounting structure 108. The second plug is secured to respective inner and outer peripheral surface portions of the effector bar and the gauge mounting structure to provide a second indirect contact area or contact bridge between the effector bar and the gauge mounting structure. This provides another location at which forces or strains applied to the effector bar are transferred to the gauge mounting structure. Second plug 116 substantially fills the annular gap from a selected location along the gauge mounting structure to the structure second end. A foam collar 115 is disposed in the annular gap and surrounds an outer peripheral surface portion of the gauge mounting structure at the selected location adjacent the second plug. The foam collar is provided to facilitate formation of the second plug of hardened epoxy resin during assembly of the effector bar.

While the strain transfer materials described above include a fitting and hardened epoxy resin, it is noted that any suitable connecting or bridging material may be provided within the annular gap formed between the effector bar and the gauge mounting structure that facilitates transfer of applied forces from the effector bar to the gauge mounting structure. For example, fittings and/or plugs of hardened epoxy resin can be secured at both opposing (e.g., first and second) ends of and/or at any other locations along the gauge mounting structure, where the fittings and/or plugs are suitably dimensioned to provide a contact or connecting bridge between corresponding inner and outer peripheral surface portions of the effector bar and the gauge mounting structure. The strain transfer materials are preferably suitably rigid to effect substantially complete transfer of forces between the effector bar and the gauge mounting structure with minimal or no absorbance of such forces by the strain transfer materials. While the preferred placement of strain transfer materials is at or near the opposing longitudinal ends of the effector bar and gauge mounting structure, the strain transfer materials may be disposed at any one or more suitable locations along the length of the effector bar depending upon a particular application.

Sensors 150, 160 are affixed at suitable locations on outer surface portions of gauge mounting structure 108 between the locations of the strain transfer materials. Preferably, the sensors are disposed at suitable locations along the gauge mounting structure where, depending upon a particular design and/or application, deformation of the effector bar and/or the gauge mounting structure will likely be the greatest or most significant. In the embodiment of FIG. 3A, sensors 150, 160 are secured on gauge mounting structure 108 at a location that is closer to the first (e.g., fixed) end (e.g., toward receptacle 24) of the gauge mounting structure in comparison to the second (e.g., free) end (e.g., toward engagement member 370) of the gauge mounting structure.

The sensors are further aligned in a longitudinal direction of both the effector bar and the gauge mounting structure and are angularly offset from each other by approximately ninety degrees on the outer periphery of the gauge mounting structure. In particular, the sensors are aligned to measure bending deflections of gauge mounting structure 108 (e.g., corresponding with bending deflections of effector bar 110 that have been translated to the gauge mounting structure via the strain transfer materials) along at least two separate axes. For example, the two separate axes may be a predefined X axis and a predefined Y axis, where both axes are oriented in the same plane and angularly offset from each other by approximately ninety degrees. However, it is noted that any suitable number of sensors (e.g., one or more) may be provided and suitably aligned on the gauge mounting structure to measure compression, elongation, and twisting of the gauge mounting structure based upon similar forces acting upon and transferred from the effector bar. For example, a third sensor may be affixed in a suitable alignment along the gauge mounting structure surface to measure other deflections (e.g., twisting, torque, etc.) of the effector bar with respect to the longitudinal dimension of the effector bar. These deflections are translated from the effector bar to the gauge mounting structure (via the strain transfer materials described above) for measurement by the sensors.

Interface device 10 employs additional sensors to measure twisting or rotational forces (e.g., yaw) applied to effector bar 110 by user 50 as illustrated in FIG. 3B. Specifically, receptacle 24 includes an open bottom portion enabling effector bar 110 to extend slightly beyond the bottom surface of floor 22. The floor bottom surface includes supports 23 as described above and supports 21 to provide sufficient space between platform 30 and floor 22 for the effector bar. Supports 21 are similar to supports 30 and are disposed on the floor bottom surface substantially perpendicular to supports 23 with effector bar 110 disposed between supports 21. A generally rectangular stop bar 29 is attached to the bottom surface of effector bar 110 and extends between supports 23. The stop bar is constructed of a suitably rigid material (e.g., a metal alloy) that is capable of being slightly deflected within its elastic limit in response to any combination of bending, twisting, tension and compression forces applied to the stop bar. While the stop bar is generally rectangular, it is noted that the stop bar may be of any suitable shape (e.g., bent or curved, V-shaped, etc.) and have any suitable exterior surface geometries (e.g., curved, multifaceted, etc.).

A pair of stops 27 is disposed adjacent each support 23, where the stops within each pair are separated by a distance sufficient to receive a corresponding end portion of stop bar 29 therebetween. The stops prevent motion of stop bar 29, thereby enabling twisting forces applied by user 50 to effector bar 110 to produce measurable strain deformations on stop bar 29. In particular, effector bar 110 is disposed within receptacle 24 in a manner enabling rotation of the effector bar relative to the receptacle. When user 50 applies rotational forces to engagement member 370, effector bar 110 attempts to rotate in the corresponding direction (e.g., yaw). Since stop bar 29 is attached to the effector bar, the stop bar similarly attempts to rotate in the corresponding direction. However, stops 27 engage and prevent motion of stop bar 29, thereby providing resistance to the user applied force and enabling that force to produce measurable strain deformations on the stop bar. This arrangement basically attaches the effector bar to the base in a generally fixed or stationary manner (e.g., with minimal or no movement) and utilizes isometric exercise to enable the user to apply forces to the interface device comparable to those applied in the real world.

Stop bar 29 includes at least one sensor to measure at least one type of strain applied by the user to the effector bar. Preferably, stop bar 29 includes strain gauge sensors 165, 175 that are arranged at suitable locations on the stop bar, preferably on the opposing longitudinal side edges of the stop bar near a pair of stops 27. These sensors measure the amount of a strain deformation applied to the stop bar as a result of the user applying twisting forces to the effector bar. By way of example only, sensor 165 may measure force applied to the effector bar in a first rotational or twisting direction (e.g., clockwise), while sensor 175 may measure forces applied to the effector bar in a second rotational or twisting direction (e.g., counter clockwise).

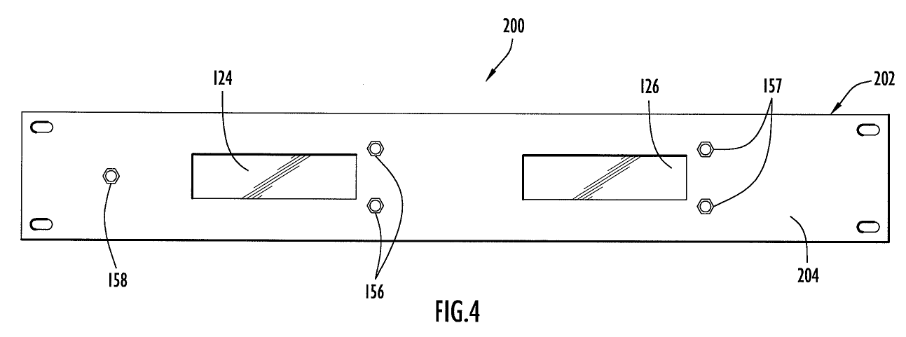

Sensors 150, 160, 165, 175 are connected to control unit 200 (FIG. 4) via appropriate wiring, where the control unit provides appropriate information to simulation system 400. The information received by the simulation system is processed to display a virtual reality scenario on display device 416 (FIG. 5). The scenario is updated in accordance with strain forces applied to the effector bar by a user. The control unit may further be configured to control the level of exertion required by a user in order to achieve a particular response in the virtual reality scenario. Resistance levels may be input to the control unit by the user via input devices 156 as described below. Alternatively, or in combination with user input, the resistance levels may be controlled by a signal processor 164 (FIG. 5) based upon conditions within the virtual reality scenario, such as changing wind conditions, changing grade of the terrain (e.g., going uphill), etc.

An exemplary control unit 200 is illustrated in FIG. 4. Specifically, the control unit is coupled to interface device 10 and receives information from strain gauge sensors 150, 160, 165, 175 as described above. Control unit 200 includes a housing 202 with front, rear, side, top and bottom walls to collectively define a housing interior for containing control circuit 210 (FIG. 5) described below. The housing front wall is in the form of a control panel 204 and includes input devices 156, 157, 158 and displays 124, 126. Input devices 156 preferably include a pair of buttons to enable a user to respectively increase and decrease gain or sensitivity to user applied forces along X and Y axes. Input devices 157 preferably include a pair of buttons to enable a user to respectively increase and decrease gain or sensitivity to user applied twisting forces. Displays 124, 126 are disposed adjacent corresponding input devices 156, 157 to respectively display real time information for the axial and twisting motions (e.g., axial sensor saturation, twist sensor saturation, gain setting, time of operation, approximate effort exerted, etc.). The displays are each preferably implemented by a Liquid Crystal Display (LCD), but may be implemented by any conventional or other display (e.g., LED, monitor, etc.). Input device 158 includes a button and generally initiates a reset operation.

An exemplary control circuit for control unit 200 is illustrated in FIG. 5. Specifically, control circuit 210 includes sensors 150, 160, 165, 175 and corresponding amplifiers 152, 162, 167, 177 and signal processor 164. A conventional power supply (not shown) provides appropriate power signals to each of the circuit components. The circuit may be powered by a battery and/or any other suitable power source (e.g., the simulation system). A power switch (not shown) may further be included to activate the circuit components. Further, the circuit may include trim potentiometers 153 to adjust the centering and range of the strain gauge sensors.

Sensors 150, 160, 165, 175 are each connected to a respective amplifier 152, 162, 167, 177. The electrical resistance of the sensors varies in response to compression and stretching of the effector and stop bars. Amplifiers 152, 162, 167, 177 basically amplify the sensor signals (e.g., in a range compatible with the type of simulation system employed). The amplified voltage value is sent by each amplifier to signal processor 164. Signal processor 164 may be implemented by any conventional or other processor and typically includes circuitry and/or converts the analog signals from the amplifiers to digital values for processing. Basically, the amplified sensor value represents the force applied by the user, where values toward the range maximum indicate greater applied force. The amplified analog value is digitized or quantized within a range in accordance with the quantity of bits within the converted digital value (e.g., −127 to +127 for eight bits signed, −32,767 to +32,767 for sixteen bits signed, etc.) to indicate the magnitude and/or direction of the applied force. Thus, amplified voltage values toward the range maximum produce digital values toward the maximum values of the quantization ranges.

The signal processor receives resistance level and reset controls from the user via input devices 156, 157, 158 as described above, and controls amplifier gain parameters to adjust interface device resistance in accordance with the user specified controls. In particular, the signal processor adjusts the gain control of the amplifiers in order to facilitate a resistance level in accordance with user input and/or the virtual reality scenario. The gain control parameter basically controls the amount of gain applied by the amplifier to an amplifier input (or sensor measurement). Since greater amplified values correspond to a greater force, increasing the amplifier gain enables a user to exert less force to achieve a particular amplified force value, thereby effectively lowering the resistance of the interface device for the user. Conversely, reducing the amplifier gain requires a user to exert greater force to achieve the particular amplified force value, thereby increasing the resistance of the interface device for the user. The signal processor further adjusts an amplifier Auto Null parameter to zero or tare the strain gauge sensors.

The signal processor is further connected to displays 124, 126 to facilitate display of certain activity or other related information as described above. The signal processor receives the amplified sensor values and determines various information for display to a user (e.g., the degree of force applied to the effector and/or stop bars at any given time, the amount of work performed by the user during a particular session, resistance levels, time or elapsed time, force applied by the user to the various axes (e.g., X, Y, Z and rotational axes), instantaneous force applied, total weight lifted, calories burned (e.g., based on the amount of work performed and user weight), resistance level setting, degree of effector and/or stop bar movement and/or any other exercise or other related information). In addition, the signal processor resets various parameters (e.g., resistance, time, work, etc.) in accordance with reset controls received from input device 158 (e.g., to provide a new session for logging information).

The signal processor processes the received information and transfers the processed information to simulation processor 414 to update and/or respond to an executing simulation. Basically, the signal processor processes and arranges the received information into suitable data packets for transmission to simulation processor 414 of simulation system 400. The signal processor may process raw digital values in any fashion to account for various calibrations or to properly adjust the values within quantization ranges. The simulation processor processes the information or data packets to update and/or respond to an executing simulation displayed on display device 416.

Operation of interface device 10 is described with reference to FIGS. 1-5. Initially, a user couples the interface device to control unit 200 (and, hence, simulation system 400). The user may adjust the interface device (e.g., engagement member height, etc.) to accommodate the user physical characteristics. The interface device is placed on an appropriate surface, where the user is typically standing on platform 30 with user legs straddling engagement member 370. The user may employ a weapon, head mounted display or other devices depending upon the particular simulation. A simulation is selected and executed on the simulation system, and the user manipulates interface device 10 to interact with the simulation. The user operates the interface device by manipulating engagement member 370 (and effector bar 110) with the user legs and/or other user lower body portion. The user applies linear and/or twisting (or rotational) forces to exert a measurable strain on the effector and/or stop bars.

Strain gauge sensors 150, 160, 165, 175 measure the strain on the effector and/or stop bars due to user manipulation of the engagement member. The signals from the strain gauge sensors are transmitted to the control unit signal processor to generate data packets for transference to simulation system 400. The simulation system processes the information or data packets to update and/or respond to an executing simulation. Thus, the force applied by the user to the effector bar results in a corresponding coordinate movement or action in the scenario displayed on the display device. In other words, user movement (e.g., similar to walking, turning, etc.) serves to indicate desired user actions or movements to the simulation system to update views and/or movement (e.g., the user traversing the simulated environment) or other actions of characters or objects within the simulation in accordance with the user movement. For example, a user leaning forward causes the simulated character to move forward. Further, the user may exert a lateral force to elicit sideways motion in the simulation, vertical force to cause the simulated character to crouch or stand, and rotational force to make the simulated character pivot. The rate of motion within the simulation is derived from the amount of force applied by the user (e.g., a greater rate of motion is produced from a greater amount of applied force).

The interface device enables the user to apply forces on the same order as those applied in the real world (e.g., to walk, turn, etc.) to provide realistic simulations and training. For example, a soldier 50 may utilize the interface device to traverse a virtual area while handling a weapon, thereby imparting the physical component to the simulation for enhanced training.

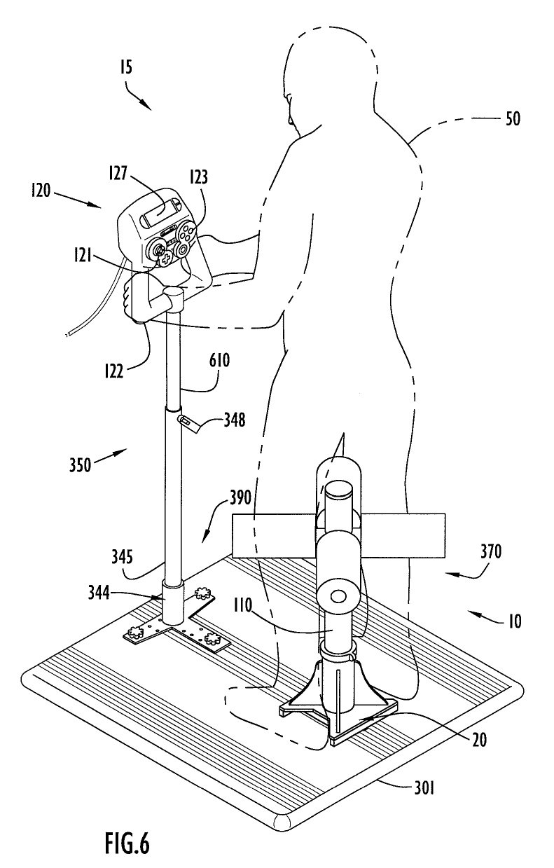

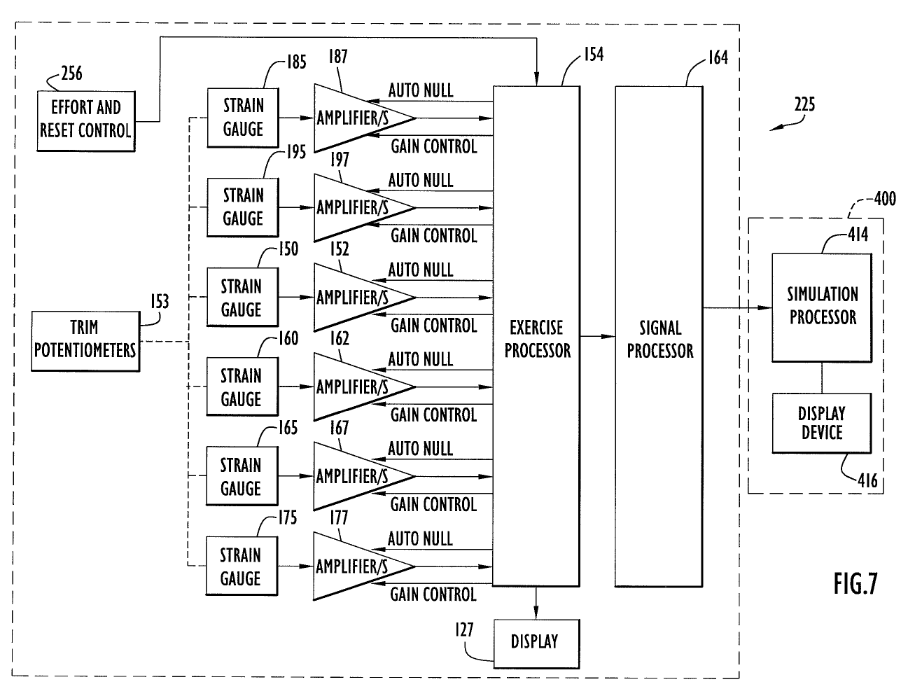

An alternative embodiment of the interface device according to the present invention is illustrated in FIG. 6. Initially, an interface device 15 is preferably coupled to simulation system 400 (FIG. 7) that provides and updates a simulation or a virtual environment in accordance with manipulation of interface device 15 by user 50 in a manner similar to that described above. The simulation system typically includes simulation processor 414 (FIG. 7) and monitor or other display device 416 as described above.

Interface device 15 includes a base platform 301, interface device 10, and a controller assembly 350. The base platform is substantially rectangular and includes a gripping surface (e.g., rubber or rubber type material, etc.) for user feet. Controller assembly 350 is secured or bolted to a front portion of base platform 301, while interface device 10 is secured to a rearward portion of the base platform. Interface device 10 is substantially similar to the interface device described above and includes sensors 150, 160, 165, 175 to measure applied forces. The sensors of interface device 10 are connected to a control circuit 225 (FIG. 7) within controller assembly 350 via appropriate wiring, where the control circuit provides appropriate information to simulation system 400. Interface device 10 is positioned a sufficient distance from the controller assembly to enable user 50 to simultaneously manipulate interface device 10 and the controller assembly as described below. Base 20 of interface device 10 is secured to base platform 301 in substantially the same manner and arrangement described above for securing interface device 10 to platform 30.

Controller assembly 350 includes a frame 390, a controller effector 610 and a controller 120. Frame 390 includes a mounting member 344 secured or bolted to a front portion of base platform 301. The mounting member includes a substantially cylindrical effector receptacle 345. Controller effector 610 includes dimensions less than those of effector receptacle 345 for insertion within that receptacle, where the controller effector and receptacle form a telescoping arrangement. The receptacle extends upward from the base and includes dimensions sufficient to receive controller effector 610. The controller effector is substantially similar to effector bar 110 described above, and is constructed of a suitably rigid material (e.g., a metal alloy) that is capable of being slightly deflected within its elastic limit in response to any combination of bending, twisting, tension and compression forces applied by the user to the controller effector. While the controller effector is generally cylindrical, it is noted that the controller effector may be of any suitable shape (e.g., bent or curved, V-shaped, etc.) and have any suitable exterior surface geometries (e.g., curved, multifaceted, etc.). The controller effector is slidably received within receptacle 345 in a substantially upright position for manipulation by a user as described below. A lock mechanism 348 may be employed to adjust the position of the controller effector within receptacle 345 in accordance with user characteristics (e.g., height, reach, etc.). Once locked into a suitable position, the controller effector is basically attached to the base platform in a fixed or stationary manner (e.g., minimal or no movement) to enable the user to apply force and perform an isometric exercise in order to interact with the simulation as described below.

Controller effector 610 typically includes at least one sensor to measure at least one type of strain applied by the user to that effector as described above. The sensors at a minimum measure force in the forward/reverse (e.g., Y axis) and left/right (e.g., X axis) axes. Additional sensors may be employed to measure up/down forces (e.g., Z axis) and rotational forces (e.g., about the Z axis). Preferably, the controller effector includes sensors 185, 195 (FIG. 7) and the sensor arrangement described above for FIG. 3A (generally without the sensor arrangement of FIG. 3B) to measure the amount of a strain deformation applied to the controller effector as a result of the user applying pushing, pulling or lateral forces to that effector. The sensors are connected to control circuit 225 within controller 120 via appropriate wiring, where the controller provides appropriate information to simulation system 400. Strain gauge measurements are processed to display a virtual reality scenario on the simulation system. The scenario is updated in accordance with strain forces applied to controller effector 610 and effector bar 110 by a user as described below.

Controller 120 is attached or secured to the controller effector upper portion. By way of example, the controller may be of the type available for conventional video games (e.g., PS2 available from Sony, XBOX available from Microsoft, GAMECUBE available from Nintendo, video gaming applications configured for use with personal computer operating systems such as Microsoft WINDOWS and Apple Mac OS X, etc.), such as the device described in U.S. Pat. No. 6,231,444, and is similar to the controllers disclosed in the aforementioned patent application and patent application publications. The controller typically includes a series of buttons 123 and a joystick 121 disposed on the controller upper portion. The controller generally includes respective signal sources (e.g., variable resistor or potentiometers) to provide signals indicating joystick motion along X (e.g., left/right motions) and Y (e.g., forward/back motions) axes. For example, joystick 121 (FIG. 7) may be associated with signal sources 125 (e.g., variable resistor or potentiometers) to provide signals indicating joystick motion along X and Y axes. However, the controller may include any quantity of any type of input devices (e.g., buttons, switches, a keypad, joystick, etc.) and signal sources disposed at any location and arranged in any fashion on the controller. The buttons and joystick may be utilized to enter any desired information (e.g., enter desired user actions for the simulation, etc.).

Further, the controller may include input devices 256 (FIG. 7) to enter and reset resistance controls and reset clock or other functions. Devices 256 may be implemented by any conventional or other input devices (e.g., buttons, slides, switches, etc.). The controller lower portion includes a generally “U”-shaped handle or grip 122 for engagement by a user.

A display 127 is further disposed on the controller upper portion and may display various information to the user (e.g., the degree of force applied to the controller effector and/or effector bar at any given time, the amount of work performed by the user during a particular session, resistance levels, time or elapsed time, force applied to the various axes (e.g., X, Y, Z and/or rotational axes), instantaneous force applied, total weight lifted, calories burned (e.g., based on the amount of work performed and user weight), resistance level setting, degree of contoller effector and/or effector bar movement and/or any other exercise or other related information). The display is preferably implemented by a Liquid Crystal Display (LCD), but may be any type of display (e.g., LED, etc.).

Controller 120 may be implemented by various devices depending on the particular simulation. For example, the controller may be implemented by a general purpose controller as described above to simulate various objects (e.g., weapon, medical or other instrument, etc.), or by a controller in the form of an item applicable to a particular simulation, such as a weapon or a medical kit.

An exemplary control circuit for interface device 15 within controller 120 is illustrated in FIG. 7. Specifically, control circuit 225 includes sensors 150, 160, 165, 175 of interface device 10 and sensors 185, 195 of controller assembly 350, corresponding amplifiers 152, 162, 167, 177, 187, 197, an exercise processor 154 and signal processor 164. A conventional power supply (not shown) provides appropriate power signals to each of the circuit components. The circuit may be powered by a battery and/or any other suitable power source (e.g., the simulation system). A power switch (not shown) may further be included to activate the circuit components. Further, the circuit may include trim potentiometers 153 to adjust the centering and range of the strain gauge sensors.

Sensors 150, 160, 165, 175, 185, 195 are each connected to a respective amplifier 152, 162, 167, 177, 187, 197. The electrical resistance of the sensors vary in response to compression and stretching of controller effector 610 and effector bar 110. Amplifiers 152, 162, 167, 177, 187, 197 basically amplify the sensor signals (e.g., in a range compatible with the type of controller employed). The amplified voltage value is sent by each amplifier to exercise processor 154. The exercise processor may be implemented by any conventional or other processor and typically includes circuitry and/or converts the analog signals from the amplifiers to digital values for processing. Basically, the amplified sensor value represents the force applied by the user, where values toward the range maximum indicate greater applied force. The amplified analog value is digitized or quantized within a range in accordance with the quantity of bits within the converted digital value (e.g., −127 to +127 for eight bits signed, −32,767 to +32,767 for sixteen bits signed, etc.) to indicate the magnitude and/or direction of the applied force. Thus, amplified voltage values toward the range maximum produce digital values toward the maximum values of the quantization ranges.

The exercise processor receives resistance level and reset controls from the user via input devices 256 as described above, and controls amplifier gain parameters to adjust interface device resistance in accordance with the user specified controls. In particular, the exercise processor adjusts the gain control of the amplifiers in order to facilitate a resistance level in accordance with user input and/or the simulation scenario. The gain control parameter basically controls the amount of gain applied by the amplifier to an amplifier input (or sensor measurement). Since greater amplified values correspond to a greater force, increasing the amplifier gain enables a user to exert less force to achieve a particular amplified force value, thereby effectively lowering the resistance of the interface device for the user. Conversely, reducing the amplifier gain requires a user to exert greater force to achieve the particular amplified force value, thereby increasing the resistance of the interface device for the user. The exercise processor further adjusts an amplifier Auto Null parameter to zero or tare the strain gauge sensors.

The exercise processor is further connected to display 127 to facilitate display of exercise or other related information. The exercise processor receives the amplified sensor values and determines various information for display to a user (e.g., the degree of force applied to the controller effector and/or effector bar at any given time, the amount of work performed by the user during a particular session, resistance levels, time or elapsed time, force applied to the various axes (e.g., X, Y, Z and/or rotational axes), instantaneous force applied, total weight lifted, calories burned (e.g., based on the amount of work performed and user weight), resistance level setting, degree of controller effector and/or effector bar movement and/or any other exercise or other related information). In addition, the exercise processor resets various parameters (e.g., resistance, time, work, etc.) in accordance with reset controls received from input devices 256 (e.g., to provide a new session for logging information) and provides sensor information to signal processor 164.

Signal processor 164 processes sensor and controller input device information and transfers this information to simulation processor 414 to update and/or respond to an executing simulation. Basically, the signal processor processes and arranges the received information into suitable data packets for transmission to simulation processor 414 of simulation system 400. The signal processor may process raw digital values in any fashion to account for various calibrations or to properly adjust the values within quantization ranges. The simulation processor processes the information or data packets to update and/or respond to an executing simulation displayed on display device 416.

Operation of interface device 15 with respect to a simulation is described with reference to FIGS. 6-7. Initially, a user couples the interface device to simulation system 400 utilizing the appropriate wiring or cables. The user may adjust the interface device (e.g., controller height, engagement member, etc.) to accommodate the user physical characteristics. The interface device is placed on an appropriate surface (e.g., floor, etc.), where the user is typically standing on base platform 301 with user legs straddling engagement member 370. A simulation is selected and executed on the simulation system, and the user engages in an exercise activity to interact with the simulation. The user operates the interface device with the user legs supported by base platform 301 and straddling engagement member 370, and the user hands placed on controller handle 122. The user grips the controller handle and applies a force to the controller and/or engagement member to exert a strain on the controller effector and/or effector bar, respectively, to produce a corresponding movement in the simulation (e.g., of a character or an object in the scenario displayed by the simulation processor). For example, a user leaning forward and manipulating the engagement member causes the character to move forward. Further, the user may exert a lateral force on the engagement member to elicit sideways motion in the simulation, exert a vertical force on the engagement member to cause the character to crouch or stand, and exert a rotational force on the engagement member to make the character pivot. The controller may be utilized to simulate a specific object for the simulation, such as a weapon. In this case, the user may further apply forces to the controller to control the viewpoint and hand position (e.g., on the weapon) in the simulation. Forces applied to the controller in the XY plane may control eye-point and/or weapon direction, while forces applied to the controller along a vertical axis may control the lifting and carrying of objects in the simulation. Twisting forces applied to the controller may be used to manipulate eye-point and/or the weapon, and may be further utilized for other simulation tasks. The rate of motion in the simulation is derived from the amount of force applied by the user (e.g., a greater rate of motion is produced from a greater amount of applied force). In addition, the user may manipulate joystick 121 and/or other controller input devices for additional actions depending upon the particular simulation.

The signals from strain gauge sensors 150, 160, 165, 175, 185, 195 and controller input devices (e.g., joystick 121, buttons 123, etc.) are transmitted to signal processor 164 to generate data packets for transference to simulation system 400. The simulation system processes the information or data packets to update and/or respond to an executing simulation. Thus, the force applied by the user to the controller effector and effector bar results in a corresponding coordinate movement or action in the scenario displayed by the simulation system. In other words, user activity serves to indicate desired user actions or movements to the simulation system to update the scene and/or the movement or actions of characters or objects within the simulation. This enables the user to apply forces during the simulation on the same order as those the user applies in the real world, thereby imparting a physical component to the simulation for enhanced training.

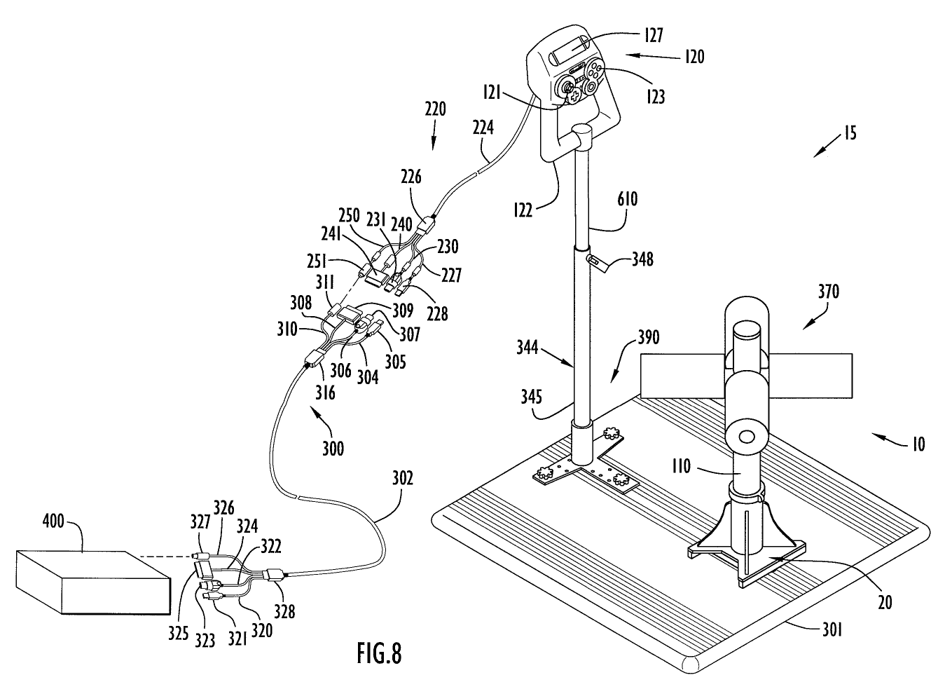

Interface device 15 may further serve as a game controller that is operable with a wide variety of video gaming or other systems including PS2, XBOX and GAMECUBE systems, and various personal or other computers (e.g., personal computers with Microsoft WINDOWS and Apple Mac OS X operating systems) as illustrated in FIG. 8. The interface device in this case serves as an exercise device requiring a user to perform isometric exercises for the user upper and/or lower body portions to interact with a video game.

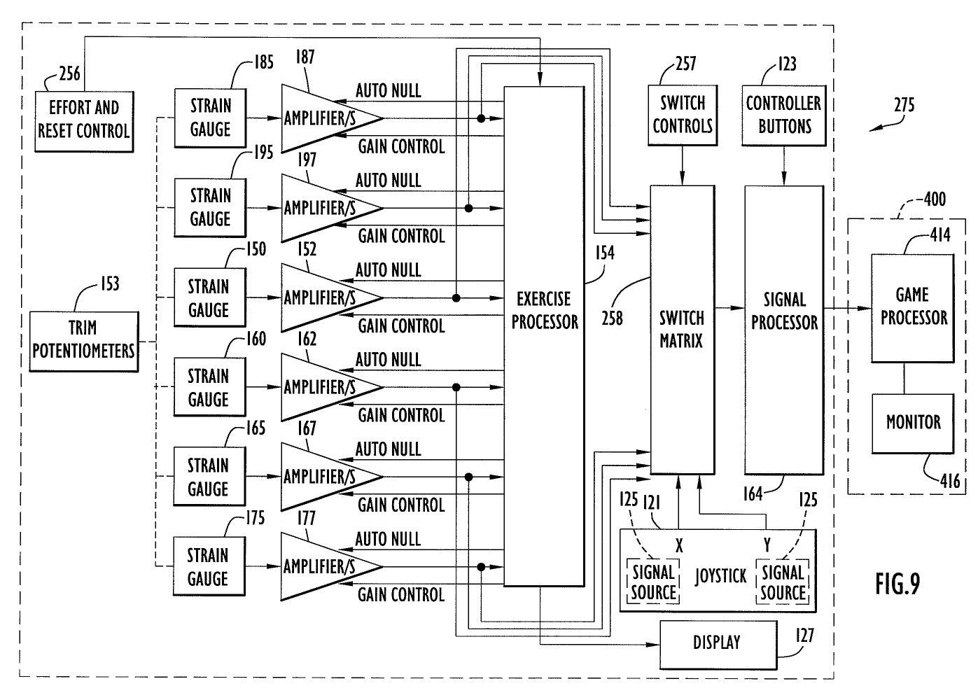

In particular, exercise device 15 is preferably coupled to simulation system 400 in the form of a gaming system and serves as a game controller to enable a user to perform isometric exercises to control a game scenario. The gaming system typically includes simulation processor 414 (FIG. 9) in the form of a game processor and a monitor or display 416. The game processor includes a storage drive and/or unit to receive computer readable media (e.g., CD, DVD, etc.) containing software for various games and a processing device to execute the software to provide games on the monitor. The gaming system may be implemented by any conventional or other processing or gaming system (e.g., microprocessor system, personal computer, video gaming system, etc.). For example, the gaming system may be implemented by conventional video games, such as PS2 available from Sony, XBOX available from Microsoft or GAMECUBE available from Nintendo.

The games generally include characters or objects that are controlled by a user via manipulation of the interface device. For example, the user may control movement and actions of a character or a vehicle (e.g., car, airplane, boat, etc.) to move through a virtual environment displayed on the monitor. The interface device includes a plurality of input devices (e.g., joystick, buttons, etc.) to enable a user to interact with the game. The gaming system receives signals from the interface device and updates the display to reflect the movements and/or actions of the character or object in accordance with user manipulation of interface device 15 as described below.

Interface device 15 includes a cable system 220 that facilitates connection and communication between controller 120 and multiple (e.g., two or more) video gaming systems. In particular, cable system 220 is connected to and extends from a rear surface of controller 120 (e.g., a controller surface that opposes the controller surface including joystick 121, buttons 123 and display 127) and at a location above controller handle 122. Cable system 220 is substantially similar to the cable system described in aforementioned U.S. Patent Application Publication No. 2006/0223634 (Feldman et al.) and includes a flexible and hollow body 224 that extends into controller 120 via an access panel or door (not shown) to receive and retain wiring that is connected with signal processor 164 (FIG. 9) within the controller. Alternatively, the cable may connect with the controller at any other suitable location and/or in any other suitable manner. A number of separately and independently extending wires are sheathed within and extend the length of cable body 224. The wires are configured for providing an electrical contact or link between signal processor 164 of controller 120 and a specific video gaming system as described below.

Cable body 224 extends a selected distance from controller 120 and connects with a generally rectangular housing 226. A number of flexible and hollow cables 227, 230, 240, 250 extend from housing 226. The wiring within cable body 224 extends within housing 226 for transfer of signals to wiring sets directed into and through a respective one of the output cables 227, 230, 240, 250. Thus, housing 226 serves as a junction location for the transfer of signals between wiring within cable body 224 and respective wiring sets of the output cables, where each output cable includes a wiring set that is configured for connection to a game controller port of a corresponding video gaming system.

Each output cable 227, 230, 240, 250 terminates in a respective connection plug 228, 231, 241, 251. The connection plugs are each configured to connect with a corresponding game controller port of a respective video gaming system. The connection plugs connect with the game controller ports in a male-female mating relationship. In particular, each connection plug includes a male component with associated metal pins and/or other contacting structure that is configured for insertion into a corresponding female component of a respective controller port. These connections establish an electrical contact between the wiring set associated with the connection plug and corresponding wiring that connects in a suitable manner with the game processor of the video gaming system. By way of example only, connection plug 251 is configured to connect with a game controller port of a GAMECUBE system, connection plug 241 is configured to connect with a game controller port of an XBOX system, connection plug 231 is configured to connect with a game controller port of a PS2 system, and connection plug 228 is configured to connect with a universal serial bus (USB) port of any suitable gaming system or personal or other computer (e.g., to facilitate control of Microsoft WINDOWS or Apple Mac OS X based gaming or other applications). However, the cable system is not limited to this exemplary configuration, but rather can include any suitable number (e.g., two or more) of connection plugs of any suitable types and configurations to facilitate connections with any types of video gaming or other systems.

Cable system 220 is of a suitable length (e.g., eight feet or greater) to facilitate a relatively easy connection between interface device 15 and video gaming system 400. In situations where the exercise system is located a considerable distance (e.g., greater than eight feet) from a video gaming system, the interface device may employ an extension cable device 300. Cable device 300 is substantially similar to the cable device disclosed in aforementioned U.S. Patent Application Publication No. 2006/0223634 (Feldman et al.) and is coupled to cable system 220 to connect the cable system with the video gaming system. In particular, extension cable device 300 includes a flexible and hollow cable 302 that extends a suitable length (e.g., about 8 feet or greater) and includes a first housing 316 at a first end of the cable and a second housing 328 at a second end of the cable. Cable 302 is substantially similar in configuration and design as cable 224 of cable system 220, where the same or substantially similar wiring extends through the cable. Further, cable 302 can include one or more wires that transfer common or shared signals for two or more wiring sets.

Each housing 316, 328 is substantially similar in configuration and design as housing 226 of cable system 220. Each housing serves as a junction location to transfer signals between the wiring within cable 302 and each of a plurality of wiring sets in a similar manner as described above for housing 226. In particular, a number of flexible and hollow cables 304, 306, 308, 310 extend from housing 316. The housing is disposed between cable 302 and these cables to facilitate a connection. Each cable 304, 306, 308, 310 couples a respective wiring set therein to housing 316 and terminates at a respective connection plug 305, 307, 309, 311. The housing transfers signals between the wiring sets and the appropriate wiring in cable 302, where one or more of the wires of cable 302 may convey signals common to the gaming systems to reduce the quantity of wires employed by the cable.

Connection plugs 305, 307, 309, 311 are complimentary with and configured for connection to corresponding connection plugs 227, 231, 241, 251 of cable system 220. In addition, the wiring sets disposed within the connection plugs of extension cable device 300 include the same or substantially similar wiring as the wiring sets disposed within the corresponding connection plugs of cable system 220. The connection plugs of the cable system and extension device connect with each other in a male-female mating relationship, where a male component of each connection plug of cable system 220 is inserted into a female component of a corresponding connection plug of extension cable device 300. This achieves an electrical contact between metal elements (e.g., pins and corresponding receiving receptacles and/or other metal complimentary contacting structures) of the plugs that further facilitates an electrical connection between the corresponding pairs of wiring sets extending within the cable system and the extension cable device. However, any other suitable connection between the connection plugs can be provided to facilitate electrical contact between corresponding pairs of wiring sets.

A number of flexible and hollow cables 320, 322, 324, 326 extend from housing 328. The housing is disposed between cable 302 and these cables to facilitate a connection. Each cable 320, 322, 324, 326 couples a respective wiring set therein to housing 328 and terminates at a respective connection plug 321, 323, 325, 327. The housing transfers signals between the wiring sets and the appropriate wiring in cable 302, where one or more of the wires of cable 302 may convey signals common to the gaming systems to reduce the quantity of wires employed by cable 302 as described above. Connection plugs 321, 323, 325, 327 are identical in configuration and design as corresponding connection plugs 227, 231, 241, 251 of cable system 220. Thus, each connection plug 321, 323, 325, 327 of the extension cable device includes a male component with associated metal pins and/or other metal contacting structure that is configured for insertion into a corresponding female component of a respective controller port to establish an electrical contact between the wiring set associated with the connection plug and corresponding wiring of the video gaming system to which the connection plug is connected.

The sets of wiring that are directed to each connection plug 321, 323, 325, 327 of the extension cable device are further the same or substantially similar as the wiring sets of a corresponding connection plugs of cable system 220. Thus, the mapping of wiring sets through cable system 220 to the various connection plugs is maintained by extension cable device 300 so as to facilitate an extension of the various wiring sets a suitable distance for providing communication between controller 120 and video gaming system 400. In addition, it is noted that extension cable device 300 can also be utilized with any video gaming system and corresponding game controller that include connecting components corresponding with any of the connection plug sets provided on the extension cable device. This enables the extension cable device to serve as a universal extension cable for a variety of different connection plug/port designs that exist for different video gaming systems and game controllers.

An exemplary control circuit for interface device 15 enabling selective assignment of functions to input devices is illustrated in FIG. 9. Specifically, control circuit 275 includes sensors 150, 160, 165, 175, 185, 195 and corresponding amplifiers 152, 162, 167, 177, 187, 197, exercise processor 154, a switching device or matrix 258 and signal processor 164. A conventional power supply (not shown) provides appropriate power signals to each of the circuit components. The circuit may be powered by a battery and/or any other suitable power source (e.g., the gaming system). A power switch (not shown) may further be included to activate the circuit components. Further, the circuit may include trim potentiometers 153 to adjust the centering and range of the strain gauge sensors. Switching device or matrix 258 assigns game functions to the controller input devices, controller effector 610 and effector bar 110 as described below.

Sensors 150, 160, 165, 175, 185, 195 are each connected to a respective amplifier 152, 162, 167, 177, 187, 197. The electrical resistance of the sensors vary in response to compression and stretching of controller effector 610 and effector bar 110. Amplifiers 152, 162, 167, 177, 187, 197 basically amplify the sensor signals (e.g., in a range compatible with the type of controller employed). The amplified voltage value is sent by each amplifier to exercise processor 154 and switching device 258. Exercise processor 154 may be implemented by any conventional or other processor and typically includes circuitry and/or converts the analog signals from the amplifiers to digital values for processing. Basically, the amplified sensor value represents the force applied by the user, where values toward the range maximum indicate greater applied force. The amplified analog value is digitized or quantized within a range in accordance with the quantity of bits within the converted digital value (e.g., −127 to +127 for eight bits signed, −32,767 to +32,767 for sixteen bits signed, etc.) to indicate the magnitude and/or direction of the applied force. Thus, amplified voltage values toward the range maximum produce digital values toward the maximum values of the quantization ranges.

The exercise processor receives resistance level and reset controls from the user via input devices 256 as described above, and controls amplifier gain parameters to adjust interface device resistance in accordance with the user specified controls. In particular, the exercise processor adjusts the gain control of the amplifiers in order to facilitate a resistance level in accordance with user input and/or the video game scenario. The gain control parameter basically controls the amount of gain applied by the amplifier to an amplifier input (or sensor measurement). Since greater amplified values correspond to a greater force, increasing the amplifier gain enables a user to exert less force to achieve a particular amplified force value, thereby effectively lowering the resistance of the interface device for the user. Conversely, reducing the amplifier gain requires a user to exert greater force to achieve the particular amplified force value, thereby increasing the resistance of the interface device for the user. The exercise processor further adjusts an amplifier Auto Null parameter to zero or tare the strain gauge sensors.

The exercise processor is further connected to display 127 to facilitate display of certain exercise or other related information. The exercise processor receives the amplified sensor values and determines various information for display to a user (e.g., the degree of force applied to a particular effector at any given time, the amount of work performed by the user during a particular session, resistance levels, time or elapsed time, force applied to the various axes (e.g., X, Y, Z and/or rotational axes), instantaneous force applied, total weight lifted, calories burned (e.g., based on the amount of work performed and user weight), resistance level setting, degree of controller effector and/or effector bar movement and/or any other exercise or other related information). In addition, the exercise processor resets various parameters (e.g., resistance, time, work, etc.) in accordance with reset controls received from input devices 256 (e.g., to provide a new session for logging information).

Switching device 258 may be employed by control circuit 275 to enable a user to selectively configure controller 120, controller effector 610 and effector bar 110 for game functions as described below. Switching device 258 receives the signals from amplifiers 152, 162, 167, 177, 187, 197 and is coupled to input devices, switch control unit 257, joystick 121 and signal processor 164. By way of example only, effector bar 110 may serve as a right controller joystick, while controller effector 610 may serve as a left controller joystick, where the functions of the joysticks with respect to a game may be selectively assigned by the user as described below. However, the controller effector and effector bar may serve as any joysticks or other input device.

The switching device receives information from amplifiers 152, 162, 167, 177, 187, 197 and is coupled to the inputs of signal processor 164. The inputs of signal processor 164 are conventionally coupled in a fixed manner to specific controller signal sources (e.g., measuring manipulation of corresponding controller input devices). Thus, the signal processor or game processor knows the controller input device associated with each input and maps game functions to those inputs (or controller input devices) in accordance with the assignments within the game software. The switching device basically enables information for the controller input devices, controller effector 610 and effector bar 110 to be selectively placed on signal processor inputs corresponding to the desired game functions. For example, gaming software may assign a car accelerator function to a controller left joystick and maps that function to a particular signal processor input expecting information from the left joystick. However, the switching device may couple the controller effector to that signal processor input, where the game processor processes the controller effector information for the accelerator function, thereby enabling the controller effector to perform that function. Thus, the various input devices (e.g., controller input devices, controller effector, effector bar, etc.) may be selectively assigned to game functions absent knowledge by the gaming software.

The switching device receives information from the exercise processor and joystick signal sources 125 and is coupled to the inputs of signal processor 164. The switching device may be implemented in hardware and/or software by any conventional or other devices capable of switching signals (e.g., switches, multiplexers, processors, cross-bar switches, switching matrix, gate arrays, logic, relays, etc.). The particular switching device embodiment utilized may depend upon the number of input devices and level of function assignment or blending desired. For example, in order to exchange functions between joysticks each with motion along an axis (e.g., to swap left-right joystick motion corresponding to a steering function or forward and backward joystick motion corresponding to an accelerator function), two double pole double throw switches may be utilized. The switches basically couple signal sources 125 of the joysticks (e.g., potentiometers measuring motion along the axis) to the signal processor inputs corresponding to the desired functions. Thus, the functions of each joystick may be performed by the other (e.g., swapped) or one joystick may perform both functions (e.g., steering and accelerator) in accordance with the connections. Applications of higher complexity with respect to blending functions may require additional selector switches and various combinations of selector switch settings.

The switching device may be implemented by devices that can switch signals in the analog or digital domain. For example, the switching device may be implemented by a processor or router that receives signals from the exercise processor and directs the signals to the signal processor inputs corresponding to the desired functions. These tasks may be accomplished in software. The switching device switches signals in accordance with controls from switch control unit 257. The switch control unit may include one or more controls disposed on controller 120, where the controls are manipulable by a user to configure the switching device directly. Alternatively, the switch control unit may include a control processor to control the switching device in accordance with the controls to achieve the desired function assignment. The controls may be implemented by any conventional or other input devices (e.g., buttons, keys, slides, etc.) to provide control signals to the switching device or control processor.

The switching device or switch control unit may alternatively provide a user interface to enable the user to enter information to configure the controller in the desired manner. The interface may be in the form of screens on a controller display or controller lights or other indicators. Further, the interface may be shown on display 416 and implemented by game processor 414. The switch control unit receives the configuration information entered by a user and controls switching device 258 to provide the appropriate signals to signal processor 164 to attain the desired configuration or function assignment.

The signals from the switching device outputs and controller input devices (e.g., buttons 123, etc.) are transmitted to a respective predetermined memory location within signal processor 164. The signal processor may be implemented by any conventional or other processor and typically includes circuitry and/or converts analog signals to digital values for processing. The signal processor samples the memory locations at predetermined time intervals (e.g., preferably on the order of ten milliseconds or less) to continuously process and send information to the game processor to update and/or respond to an executing gaming application.

Basically, the signal processor processes and arranges the sampled information into suitable data packets for transmission to game processor 414 of gaming system 400. The signal processor may process raw digital values in any fashion to account for various calibrations or to properly adjust the values within quantization ranges. The data packets are in a format resembling data input from a standard peripheral device (e.g., game controller, etc.). For example, the processor may construct a data packet that includes the status of all controller input devices (e.g., joystick 121, buttons 123, etc.) and the values of each sensor. By way of example only, the data packet may include header information, X-axis information indicating a corresponding sensor force and joystick measurement along this axis, Y-axis information indicating a corresponding sensor force and joystick measurement along this axis, rudder or steering information, throttle or rate information and additional information relating to the status of input devices (e.g., buttons, etc.). Additional packet locations may be associated with data received from controller or other input and/or exercise devices coupled to the signal processor, where the input devices may represent additional operational criteria for the scenario (e.g., the firing of a weapon in the scenario when the user presses an input button, throttle, etc.). The game processor processes the information or data packets in substantially the same manner as that for information received from a conventional peripheral (e.g., game controller, etc.) to update and/or respond to an executing gaming application (e.g., game, etc.) displayed on display 416 of the gaming system.

Control circuit 275 (FIG. 9) of the interface device controller is configured for effective communication and operability as a game controller with each of the video gaming systems associated with the wiring sets and cable connectors of the cable system. In particular, when cable system 220 (optionally including extension cable device 300) is connected with a video gaming system in the manner described above, controller signal processor 164 identifies the specific video gaming system with which control unit 120 is connected upon receiving one or more initial electrical signals (e.g., one or more “wake-up” signals) from the video gaming system. When the specific video gaming system is identified, the controller signal processor processes and arranges signals into suitable data packets for transmission to and recognition by the video gaming system during a gaming application as described above.

Operation of interface device 15 with respect to a gaming application is described with reference to FIGS. 8-9. Initially, a user couples the interface device to video gaming system 400 utilizing the appropriate connection plug or plugs of cable system 220 and/or extension cable device 300 (e.g., the particular connection plug or plugs compatible with the gaming system). Based upon the video gaming system utilized and/or the particular gaming application that is to be executed, the user may selectively assign game functions to the joystick, the controller effector, the effector bar and/or other input devices as described above. The user may adjust the interface device (e.g., controller height, engagement member, etc.) to accommodate the user physical characteristics. The interface device is placed on an appropriate surface (e.g., floor, etc.), where the user is typically standing on base platform 301 with user legs straddling engagement member 370 and user hands gripping controller handle 122.

During an initial set-up sequence (e.g., when the video gaming system is powered on), signal processor 164 (FIG. 9) of controller 120 receives one or more initial signals from video gaming system 400. The signal processor identifies the specific video gaming system based on those initial signals and arranges data in suitable data packets for recognition by the identified system. A game is selected and executed on the gaming system, and the user engages in an exercise to interact with the game. The user operates the interface device with the user legs supported by base platform 301 and straddling engagement member 370 and the user hands placed on controller handle 122. The user grips the controller handle and applies a force to the controller and/or engagement member to exert a strain on the controller effector and/or effector bar, respectively, to produce a corresponding game movement (e.g., of a character or an object in the scenario displayed by the game processor). For example, a user leaning forward and manipulating the engagement member causes the character to move forward. Further, the user may exert a lateral force on the engagement member to elicit sideways motion in the game, exert a vertical force on the engagement member to cause the character to crouch or stand, and exert a rotational force on the engagement member to make the character pivot. The user may further apply forces to the controller to control the viewpoint in the game. Forces applied to the controller in the XY plane may control view and/or direction, while vertical axis forces applied to the controller may control the lifting and carrying of objects in the game. Twisting forces applied to the controller may be used for other tasks. The rate of motion within the game is derived from the amount of force applied by the user (e.g., a greater rate of motion is produced from a greater amount of applied force). In addition, the user may manipulate joystick 121 and/or other controller input devices for additional actions depending upon the particular game and user function assignments.

The signals from strain gauge sensors 150, 160, 165, 175, 185, 195 and controller input devices (e.g., joystick, buttons, etc.) are transmitted to the controller signal processor to generate data packets for transference to video gaming system 400. The gaming system processes the information or data packets in substantially the same manner as that for information received from a conventional peripheral (e.g., game controller, etc.) to update and/or respond to an executing gaming application. Thus, the force applied by the user to the controller effector and effector bar results in a corresponding coordinate movement or action in the scenario displayed on the video gaming display in accordance with the function assigned to those items by the user. In other words, user exercise serves to indicate desired user actions or movements to the gaming system to update movement or actions of characters or objects within the game in accordance with the function assigned to the controller effector and effector bar. For example, when the user assigns the controller effector accelerator functions and the effector bar steering functions, application of a forward force to the controller may serve as the accelerator, while twisting forces applied to the engagement member may serve as the steering function.

As noted above, a single signal processor is implemented in control circuit 275 of interface device 15, where the signal processor is capable of communicating with a number of different video gaming systems in the manner described above. However, the present invention is not limited to the use of a single processor. Rather, interface device 15 may include multiple processors (e.g., two or more), where each processor is configured to enable communication of signals between the interface device and at least one corresponding video gaming system as disclosed in the aforementioned patent application and patent application publications.

In addition, the electrical connection and/or communication between the one or more processors of interface devices 10, 15 and the sensors and/or simulation or gaming system are not limited to a cable or wiring system and/or extension cable device as described above. Rather, any suitable wired and/or wireless communication links can be provided that facilitate the communications (e.g., between one or more processors of the interface devices and the gaming or simulation system, between the sensors and control circuits, etc.).

It will be appreciated that the embodiments described above and illustrated in the drawings represent only a few of the many ways of implementing a method and apparatus for operatively controlling a virtual reality scenario with an isometric exercise system.

Interface device 10 and the corresponding components (e.g., effector bar, base, support platform, engagement member, collar, contact members, stop bar, stops, supports, etc.) may be of any quantity, size or shape, may be arranged in any fashion and may be constructed of any suitable materials. The base may be of any size or shape. The recesses may be of any quantity, size or shape and may be defined in the base at any suitable locations. The base may be constructed of any suitable materials and may be secured to the platform via any conventional or other securing mechanism (e.g., bolt, screw, pin, clamp, etc.). The receptacle may be of any quantity, shape or size and may be disposed at any suitable location on the base to receive the effector bar. The locking mechanism may include any type of locking device (e.g., friction device, clamp, peg and hole arrangement, etc.) to releasably maintain an interface device component in a desired position or orientation to accommodate a user.

The support members may be of any quantity, shape, size or suitable materials and may be disposed on the base at any suitable locations in any desired arrangements. The contact members may be of any quantity, shape or size, may be constructed of any suitable materials and may be arranged in any fashion (e.g., ‘T’, ‘X’ or ‘Y’ configuration, cross or plus configuration, star configuration, any angular offset, etc.). The contact members may include any desired foam or padding for user comfort. The ring may be of any quantity, shape or size, may be constructed of any suitable materials and may be implemented by any suitable device with an opening of any shape or size sufficient to receive the effector bar. The ring may be secured to the effector bar via any conventional or other securing mechanisms (e.g., clamp, O-ring, etc.). The engagement member and platform may accommodate any desired user body portions (e.g., legs, arms, torso, etc.), where the user may utilize the device in any suitable position (e.g., sitting down, standing, lying down, etc.).

The stop bar may be of any quantity, shape or size and may be secured to the effector bar or other interface device components in any fashion to oppose rotational or other motion of the effector bar. The stops may be of any quantity, shape or size, may be constructed of any suitable materials and may be disposed at any suitable locations to restrict the stop bar. The stops may be disposed at any suitable distance from the stop bar to provide any desired range of motion (e.g., ranging from no stop bar motion or stationary to any degree of motion). The supports and collar may be of any quantity, shape or size, may be constructed of any suitable materials and may be disposed at any suitable locations. The supports may be omitted, or arranged in any fashion and utilized to elevate the base to any suitable distance above the support platform. The support platform may be of any quantity, size or shape and may be constructed of any suitable materials. The base may be disposed at any suitable location on the platform.

Interface device 15 and the corresponding components (e.g., controller effector, frame, base platform, controller, etc.) may be of any quantity, size or shape, may be arranged in any fashion and may be constructed of any suitable materials. The base platform may be of any size or shape and constructed of any suitable materials. The base of interface device 10 may be secured to the platform at any suitable location via any conventional or other securing mechanism (e.g., bolt, screw, pin, clamp, etc.). The frame and mounting member may be of any quantity, shape or size, may be constructed of any suitable materials and may be disposed at any suitable location on the base platform. The receptacle may be of any quantity, shape or size to receive the controller effector. The locking mechanism may include any type of locking device (e.g., friction device, clamp, peg and hole arrangement, etc.) to releasably maintain an interface device component in a desired position or orientation to accommodate a user. The controller assembly and interface device 10 may be disposed at any locations on the base platform enabling simultaneous use by a user.

The effector bar, controller effector and stop bar of the interface devices may be constructed of any suitable materials that preferably are subject to measurable deflection within an elastic limit of the materials when subjected to one or more straining or other forces by the user. The effector bar, controller effector and stop bar may have any suitable geometric configurations, where two or more effectors (e.g., controller effector and/or effector bar) may be combined in any suitable manner to yield a device that conforms to a desired design for a user for a particular application. The effector bar and controller effector may be positioned at any desired orientation or angle (e.g., the receptacle may be angled, the effector bar and/or controller effector may be disposed within the receptacle at an angle, the effector bar and/or controller effector may be adjustable to any desired angle by a user, etc.). The interface devices may further include various exercise mechanisms to control the simulation or video game and provide further exercise for a user (e.g., cycling, stair mechanism, etc.).

Any suitable number of any types of sensors (e.g., strain gauges, etc.) may be applied to the controller effector, effector bar, stop bar and/or gauge mounting structure to facilitate the measurement of any one or more types of strain or other forces applied by the user (e.g., bending forces, twisting forces, compression forces and/or tension forces). The interface devices may be utilized on any suitable surface (e.g., floor, platform, ground, etc.) and may be adjustable in any fashion (e.g., any dimension, controller and/or engagement member height, etc.) via any types of arrangements of components (e.g., telescoping arrangement, overlapping arrangement, extender components, etc.) to accommodate user physical characteristics.

The sensors may be constructed of any suitable materials, may be disposed at any locations on the effector bar, controller effector, stop bar and/or gauge mounting structure and may be of any suitable type (e.g., strain gauge, etc.). Further, the sensors may include any electrical, mechanical or chemical properties that vary in a measurable manner in response to applied force to measure force applied to an object. The sensors may include any desired arrangement. The interface devices may include any suitable number of controller effectors, effector bars and gauge mounting structures secured within corresponding controller effectors and effector bars. The gauge mounting structures may be constructed of any suitable materials that preferably permit their deformation within an elastic limit as a result of bending, twisting, compression and/or torque forces applied to the corresponding controller effectors and effector bars. Preferably, the gauge mounting structures are constructed of materials that are more compliant and have greater flexibility than the controller effectors and effector bars to which they are secured when each are subjected to the same amount and/or type of forces. The gauge mounting structures may have any suitable geometric configurations that preferably facilitate securing of one or more gauge mounting structures within a corresponding controller effector and/or effector bar.

The gauge mounting structures may be hollow or solid. For example, in an embodiment where a gauge mounting structure is hollow, the strain gauge sensors may be secured at suitable locations to outer surface portions on the gauge mounting structure with associated wiring extending within the annular gap between the gauge mounting structure and the corresponding controller effector or effector bar. Alternatively, the gauge mounting structures may be solid structures, where both the strain gauges and wiring are secured and/or extend from outer surface portions of the gauge mounting structures.

Strain transfer materials may be provided of any suitable types, sizes and configurations to facilitate transfer of applied forces from the controller effector and/or effector bar to one or more gauge mounting structures disposed therein. The strain transfer materials can be formed of any suitable materials that effect a transfer of at least a portion of the applied forces from the controller effector and/or effector bar to the gauge mounting structure. The strain transfer materials may be disposed at any one or more suitable locations within the corresponding controller effector and/or effector bar to provide a connection at selected surface locations between those items and the gauge mounting structures. Alternatively, gauge mounting structures may be designed to include one or more suitably sized and configured outer peripheral sections that frictionally engage with interior peripheral surface portions of the corresponding controller effector and/or effector bar so as to facilitate one or more strain transfer contacting surfaces between the gauge mounting structures and the corresponding effectors.

The controller for interface device 15 may be of any shape or size, may be constructed of any suitable materials, and may be of the type of any commercially available or other game controller (e.g., those for use with PS2, XBOX, GAMECUBE, etc.). The controller may include any quantity of any types of input devices (e.g., buttons, slides, joysticks, track type balls, etc.) disposed at any locations and arranged in any fashion. The controller may include any quantity of any types of signal source devices to generate signals in accordance with input device manipulation (e.g., variable resistors or potentiometers, switches, contacts, relays, sensors, strain gauges, etc.). The signal sources may correspond with any quantity of axes for an input device. Any controller input devices may be implemented as force sensing or isometric devices, while the controller input devices may be assigned to any suitable game or simulation functions. The controller may include any quantity or combination of force sensing input devices and motion input devices. The controller handle may be of any quantity, shape or size and may be disposed at any location to receive force applied by a user. Alternatively, the user may apply force directly to the controller effector and/or effector bar. The controller may alternatively be in the shape of any object in accordance with a particular simulation (e.g., a weapon, medical or other instrument, etc.).

The controller effector, effector bar and/or other input devices may be assigned the gaming or simulation functions of any desired input devices. The switching device may be implemented by any quantity of any conventional or other devices capable of switching signals (e.g., switches, multiplexers, cross-bar switch, analog switches, digital switches, routers, logic, gate arrays, logic arrays, processor, etc.). The switch controls may include a control processor to control the switching device in accordance with the controls to achieve the desired function assignment. The switch controls may be implemented by any conventional or other control or input devices (e.g., processor, slides, switches, buttons, etc.) to provide control signals to the switching device or control processor. The switching device or switch controls may alternatively provide a user interface to enable the user to enter information to configure the controller in the desired manner. The interface may be in the form of screens on a controller display or controller lights or other indicators. Further, the interface may be shown on the gaming or simulation system display and implemented by the simulation or game processor of the simulation system. The control processor may be implemented by any conventional or other processor or circuitry (e.g., microprocessor, controller, etc.). The switching device may direct signals from any quantity of inputs to any quantity of outputs in accordance with user-specified or other controls and may map any input devices and/or exercise mechanisms to any suitable simulation or game functions. The switching device may be disposed internal or external of the controller or control unit.

The simulation system may be implemented by any quantity of any personal or other type of computer or processing system (e.g., IBM-compatible, Apple, Macintosh, laptop, palm pilot, microprocessor, gaming consoles such as the XBOX system from Microsoft Corporation, the PLAY STATION 2 system from Sony Corporation, the GAMECUBE system from Nintendo of America, Inc., etc.). The simulation system may be a dedicated processor or a general purpose computer system (e.g., personal computer, etc.) with any commercially available operating system (e.g., Windows, OS/2, Unix, Linux, etc.) and/or commercially available and/or custom software (e.g., communications software, application software, etc.) and any types of input devices (e.g., keyboard, mouse, microphone, etc.). The simulation or gaming system may execute software from a recordable medium (e.g., hard disk, memory device, CD, DVD or other disks, etc.) or from a network or other connection (e.g., from the Internet or other network).

The controller or control unit may arrange data representing force measurements by sensors and other information into any suitable data packet format that is recognizable by the gaming system or host computer system receiving data packets from the controller or control unit. The data packets may be of any desired length, include any desired information and be arranged in any desired format. Any suitable number of any type of conventional or other displays may be connected to the controller, control unit and simulation or gaming system to provide any type of information relating to a particular session. A display may be located at any suitable location on or remote from the control unit, controller and simulation or gaming system.

Each of the interface devices may be adjustable in any fashion (e.g., any dimension, controller and/or engagement member height, controller and/or engagement member orientation or distance to the user, etc.) via any types of arrangements of components (e.g., telescoping arrangement, overlapping arrangement, extender components, etc.) to accommodate user physical characteristics.

The processors (e.g., control, exercise, signal, game or simulation, switching device, etc.) may be implemented by any quantity of any type of microprocessor, processing system or other circuitry, while the control circuits may be disposed at any suitable locations on the interface devices, within the controller or control unit, or alternatively, remote from the interface devices. The control circuits and/or signal processor may be connected to one or more game processors or host computer systems via any suitable peripheral, communications media or other port of those systems. The signal processors may further arrange digital data (e.g., force or other measurements by sensors, controller information, etc.) into any suitable data packet format that is recognizable by the game processor or host computer system receiving data packets from the signal processors. The data packets may be of any desired length, include any desired information and be arranged in any desired format. In addition, the signal processor may arrange the packets for selective assignment of game or simulation functions by placing data from selected input devices in packet locations associated with desired functions for those devices.

The signal processor may sample the information at any desired sampling rate (e.g., seconds, milliseconds, microseconds, etc.), or receive measurement values or other information in response to interrupts. The analog values may be converted to a digital value having any desired quantity of bits or resolution. The processors (e.g., control, signal, exercise, etc.) may process raw digital values in any desired fashion to produce information for transference to the display, game processor or host computer system. This information is typically dependent upon a particular application. The correlation between the measured force or exercise motion and provided value for that force or motion may be determined in any desired fashion. By way of example, the amplified measurement range may be divided into units corresponding to the resolution of the digital value. For an eight bit unsigned digital value (e.g., where the value indicates the magnitude of force), each increment represents 1/256 of the voltage range. With respect to a five volt range, each increment is 5/256 of a volt, which is approximately 0.02 volts. Thus, for an amplified force measurement of three volts, the digital value may correspond to approximately 150 (e.g., 3.0/0.2).

Any suitable number of any types of conventional or other circuitry may be utilized to implement the control circuits, amplifiers, sensors, trim potentiometers, switching device and processors (e.g., exercise, control, signal, etc.). The amplifiers may produce an amplified value in any desired voltage range, while the A/D conversion may produce a digitized value having any desired resolution or quantity of bits (e.g., signed or unsigned). The control circuits may include any quantity of the above or other components arranged in any fashion. The resistance change of the sensors may be determined in any manner via any suitable conventional or other circuitry. The amplifiers and processors (e.g., exercise, signal, etc.) may be separate within a circuit or integrated as a single unit. Any suitable number of any type of conventional or other displays may be connected to the processors (e.g., exercise, signal, control, simulation or game, etc.), where the processors may provide any type of information relating to a particular session (e.g., results from isometric exercises including force and work, results from motion exercise including speed and distance traveled, calories burned, weight lifted, etc.).

The control unit may be of any quantity, shape or size. The control panel may include any quantity of any types of input devices (e.g., buttons, keypad, etc.) disposed at any suitable locations. The displays may be of any quantity and disposed at any suitable locations on the control panel. The displays may be implemented by any conventional or other displays (e.g., LCD, LED, monitor, etc.) and may display any desired information, while the input devices may be utilized to enter or modify any desired information or parameters (e.g., gain, etc.). The control unit may communicate with the interface device and simulation system in any desired fashion (e.g., wired, wireless, etc.), and transfer any suitable information in any desired format or protocol.

The control circuits and/or signal processors of the controller and/or control unit may be connected to one or more game or simulation processors of video gaming or host computer systems via any suitable peripheral, communications media or other port of those systems. Any suitable number and types of wired and/or wireless devices may be provided to facilitate communications between the interface devices and control unit and between the interface devices (or control unit) and video gaming or simulation systems. For example, any suitable number of cables can be provided and configured for connection with each other, with each cable including one or more suitable wiring sets with one or more wires, to facilitate connection with two or more video gaming systems. The cable junctions of the cable system and extension cable device may transfer signals between the wires within the cable and wiring sets in any fashion (e.g., direct connection of wires, connection to a terminal, etc.). The wiring of the cable may be connected to any quantity of wiring sets, where the cable wiring may utilize one or more wires to transfer gaming signals common to any quantity of wiring set wires to reduce the quantity of wires employed in the cable. Alternatively, the cable may include a dedicated wire for each wiring set wire. Any suitable number and types of housings or other structures may be connected with one or more cables to facilitate transfer of signals between wiring extending within a cable and wiring sets for transfer into separate cables. Any suitable number and types of connectors (e.g., male and/or female connection plugs) may be provided to facilitate connection and a communication link between a game controller and one or more different video gaming systems. The cable system and extension cable device may include cables of any suitable lengths. The wake-up signal may include any signal or desired information to identify a gaming system (e.g., voltage or current level, gaming system identifier, etc.).

Any suitable number and types of wireless communication links (e.g., transmitters, receivers and/or transceivers) that send and/or receive any suitable types of signals (e.g., RF and/or IR) can be provided for connection with the controller or control unit and/or one or more video gaming or simulation systems and with the interface device and control unit. One or more signal processors may be connected with one or more wireless communication links to facilitate communications between a controller or control unit and one or more video gaming or simulation systems. In addition, one or more signal processors may be provided within a communication device (e.g., a transceiver), connection plugs and/or other connecting structure that connects with one or more video gaming or simulation systems, where the signal processors are configured to identify video gaming or simulation systems to which they are connected and convert data transmissions for recognition by a controller and/or a video gaming or simulation system that are linked to each other.

Further, a universal adaptor may be provided that is generic and configured to connect with any selected types of controllers and video gaming or simulation systems, where the universal adaptor includes one or more suitable signal processors to identify a specific video gaming or simulation system and to effectively convert data transmissions for recognition by each of the controller and the specific video gaming or simulation system that is connected to the controller via the universal adaptor. The universal adaptor may include one or more cables to sheath one or more sets of wiring and/or one or more suitable wireless communication devices (e.g., transmitters, receivers and/or transceivers, etc.) to facilitate wireless communications.

Any suitable number of additional input devices may be provided for the interface devices to enhance video game or simulation scenarios. The input devices may be provided on any suitable number of control panels that are accessible by the user during system operation and have any suitable configuration (e.g., buttons, switches, keypads, etc.). The exercise mechanisms (e.g., foot pedals, stairs, ski type exercisers, treadmills, etc.) may provide any isokinetic and/or isotonic exercise features in addition to or instead of the isometric exercise features provided by the controller effector and effector bar. The exercise mechanisms may be assigned to any desired game or simulation functions in the manner described above and may further be resistance controlled by the exercise processor, where control signals may be transmitted to a resistance or braking device or the amount of effort required by the user may be modified.

The resistance level for the controller effector, effector bar and/or exercise mechanisms may be controlled by adjusting amplifier or other parameters. Alternatively, the resistance level may be controlled based on thresholds entered by a user. For example, the processors (e.g., exercise and/or signal processors) may be configured to require a threshold resistance level be achieved, which is proportionate to the amount of straining force applied by the user to one or more effectors or to an amount of motion or force applied to an exercise mechanism (e.g., rate of stair climbing or pedaling, etc.) before assigning appropriate data values to the data packets to be sent to the game processor or host computer. Threshold values for the change in resistance may be input to the processor by the user via an appropriate input device (e.g., a keypad).

It is to be understood that the software of the interface devices and/or processors (e.g., control, exercise, game or simulation, signal, switching devices, etc.) may be implemented in any desired computer language, and could be developed by one of ordinary skill in the computer and/or programming arts based on the functional description contained herein. Further, any references herein of software performing various functions generally refer to computer systems or processors performing those functions under software control. The processors (e.g., control, exercise, signal, switching device, etc.) may alternatively be implemented by hardware or other processing circuitry, or may be implemented on the game processor or host system as software and/or hardware modules receiving the sensor and/or input device information or signals. The various functions of the processors (e.g., control, exercise, signal, game or simulation, switching devices, etc.) may be distributed in any manner among any quantity (e.g., one or more) of hardware and/or software modules or units, processors, computer or processing systems or circuitry, where the processors, computer or processing systems or circuitry may be disposed locally or remotely of each other and communicate via any suitable communications medium (e.g., LAN, WAN, Intranet, Internet, hardwire, modem connection, wireless, etc.). The software and/or algorithms described above may be modified in any manner that accomplishes the functions described herein.

The terms “upward”, “downward”, “top”, “bottom”, “side”, “front”, “rear”, “upper”, “lower”, “vertical”, “horizontal”, “height”, “width”, “length”, “forward, “backward”, “left”, “right” and the like are used herein merely to describe points of reference and do not limit the present invention to any specific orientation or configuration.

The present invention interface devices are not limited to the gaming or simulation applications described above, but may be utilized as a peripheral for any processing system, software or application. The controller effector and effector bar may be utilized either individually, in any combination (e.g., any quantity of effector bars and controller effectors may be utilized in an interface device) or in any combination with any other exercise or input devices, and these effectors and/or exercise devices may be assigned to control any desired simulation or game functions (e.g., by use of the switching device, etc.). Further, interface device 10 may include a controller enabling entry of any desired information to directly interface a simulation or gaming system. Moreover, interface device 10 and the controller assembly may be each be mounted to any suitable surfaces (e.g., platform, ground, floor, wall, etc.) for a simulation or game. In addition, a plurality of interface devices 10, 15 may be utilized locally or remotely for a simulation or game (e.g., via the interface devices or corresponding simulation or game systems communicating locally or remotely via a local or wide area network) to provide group participation.

From the foregoing description, it will be appreciated that the invention makes available a novel method and apparatus for operatively controlling a virtual reality scenario with an isometric exercise system, wherein an isometric exercise system serves as a controller for simulations or video games to impart a physical component to physical training simulations or video game play.

Having described preferred embodiments of a new and improved method and apparatus for operatively controlling a virtual reality scenario with an isometric exercise system, it is believed that other modifications, variations and changes will be suggested to those skilled in the art in view of the teachings set forth herein. It is therefore to be understood that all such variations, modifications and changes are believed to fall within the scope of the present invention as defined by the appended claims.

1-46. (canceled)

47. A peripheral device to manipulate a virtual reality scenario of a host processing system in accordance with physical activity of a user comprising:
a user support to support at least one body portion of a user thereon, wherein said user support includes:
a sensing unit to measure forces applied by said at least one body portion supported by said user support and to transfer information associated with said force measurement to said host processing system in order to update said virtual reality scenario in accordance with an amount of force applied by said user.

48. The peripheral device of claim 47, wherein said sensing unit measures forces applied by a user lower body portion supported by said user support.

49. The peripheral device of claim 47, wherein said sensing unit measures forces applied by a user upper body portion supported by said user support.

50. The peripheral device of claim 47, wherein said sensing unit measures forces applied by a user body in a leaning orientation on said user support, and said host processing system updates said virtual reality scenario in accordance with said leaning orientation.

51. The peripheral device of claim 47, wherein said sensing unit provides an isometric exercise for said user and measures forces applied by said user during performance of said isometric exercise.

52. The peripheral device of claim 47, wherein said host processing system includes a gaming system.

53. A method of manipulating a virtual reality scenario of a host processing system in accordance with physical activity of a user comprising:
(a) supporting at least one body portion of a user on a user support;
(b) measuring forces applied by said at least one body portion supported by said user support via a sensing unit; and
(c) transferring information associated with said force measurement to said host processing system in order to update said virtual reality scenario in accordance with an amount of force applied by said user.

54. The method of claim 53, wherein step (b) further includes:
(b.1) measuring forces applied by a user lower body portion supported by said user support.

55. The method of claim 53, wherein step (b) further includes:
(b.1) measuring forces applied by a user upper body portion supported by said user support.

56. The method of claim 53, wherein step (b) further includes:
(b.1) measuring forces applied by a user body in a leaning orientation on said user support; and
step (c) further includes:
(c.1) updating said virtual reality scenario in accordance with said leaning orientation.

57. The method of claim 53, wherein step (b) further includes:
(b.1) providing an isometric exercise for said user; and
(b.2) measuring forces applied by said user during performance of said isometric exercise.

58. The method of claim 53, wherein said host processing system includes a gaming system.
